(19) United States
(12) Patent Application Publication
(10) Pub. No.: US 2026/0358622 A1
(43) Pub. Date: Nov. 12, 2026

(54) COMBINATION OF SUSPENSION SYSTEM WITH OUTER ACTUATION SYSTEM FOR TWO-DIMENSIONAL MICROELECTROMECHANICAL SYSTEM MIRROR SCANNER

(71) Applicant: Infineon Technologies AG, Neubiberg (DE)

(72) Inventors: Theresa LUTZ, Göttingen (DE); Malika BELLA, Ottobrunn (DE); Stephan Gerhard ALBERT, München (DE)

(21) Appl. No.: 19/200,082

(22) Filed: May 6, 2025

(51) Int. Cl. G02B 26/08; G02B 26/10

(52) U.S. Cl. CPC G02B 26/0858; G02B 26/101

(57) ABSTRACT

A microelectromechanical system (MEMS) device includes a mirror system configured to rotate about a first rotation axis and a second rotation axis; a frame that is rotationally fixed; an inner suspension assembly mechanically coupled to the mirror system, the inner suspension assembly comprising a plurality of suspension beams configured to suspend the mirror system over a frame recess, and to enable the mirror system to rotate about the first rotation axis and to rotate about the second rotation axis; and an outer actuation system assembly coupled to and between the inner suspension assembly and the frame, the outer actuation system assembly configured to suspend the mirror system and the inner suspension assembly over the frame recess, and to actuate deflections of the plurality of suspension beams to cause the mirror system to rotate about the first rotation axis and to rotate about the second rotation axis.

### BACKGROUND

A scanning system may use two-dimensional scanning to scan one or more light beams within a field-of-view (FOV) according to a scanning pattern. The scanning system may use two scanning axes, including a first scanning axis that is configured to steer the one or more light beams in a first direction at a first scanning frequency and a second scanning axis that is configured to steer the one or more light beams in a second direction at a second scanning frequency. The second scanning axis is typically perpendicular to the first scanning axis. Different scanning patterns can be obtained by using different fixed frequency ratios between the first scanning frequency and the second scanning frequency. Synchronizing the first scanning frequency and the second scanning frequency to maintain a fixed frequency ratio is important to maintain a particular scanning pattern during a scanning operation.

### SUMMARY

In some implementations, a microelectromechanical system (MEMS) device includes a mirror system including a connector ring and a mirror body coupled to the connector ring, wherein the mirror body, arranged inside the connector ring, is configured to rotate about a first rotation axis and to rotate about a second rotation axis that is perpendicular to the first rotation axis; a frame that is rotationally fixed, the frame comprising a frame recess over which the mirror system is suspended; an inner suspension assembly mechanically coupled to the mirror system, the inner suspension assembly comprising a plurality of suspension beams configured to suspend the mirror system over the frame recess, and to enable the mirror system to rotate about the first rotation axis and to rotate about the second rotation axis; and an outer actuation system assembly coupled to and between the inner suspension assembly and the frame, the outer actuation system assembly configured to suspend the mirror system and the inner suspension assembly over the frame recess, and to actuate deflections of the plurality of suspension beams to cause the mirror system to rotate about the first rotation axis and to rotate about the second rotation axis, wherein the outer actuation system assembly includes a plurality of actuation beams and a plurality of piezoelectric actuators coupled to the plurality of actuation beams, and the plurality of piezoelectric actuators are configured to induce deflections of the plurality of actuation beams to actuate the deflections of the plurality of suspension beams.

In some implementations, a microelectromechanical system (MEMS) device includes a mirror system including a connector ring and a mirror body coupled to the connector ring, wherein the mirror body, arranged inside the connector ring, is configured to rotate about a first rotation axis and to rotate about a second rotation axis that is perpendicular to the first rotation axis; a frame that is rotationally fixed, the frame comprising a frame recess over which the mirror system is suspended; an inner suspension assembly mechanically coupled to the mirror system, the inner suspension assembly comprising a plurality of suspension beams configured to suspend the mirror system over the frame recess, and to enable the mirror system to rotate about the first rotation axis and to rotate about the second rotation axis; and an outer actuation system assembly coupled to and between the inner suspension assembly and the frame, the outer actuation system assembly configured to suspend the mirror system and the inner suspension assembly over the frame recess, and to actuate deflections of the plurality of suspension beams to cause the mirror system to rotate about the first rotation axis and to rotate about the second rotation axis, wherein the outer actuation system assembly includes a plurality of actuation beams configured to deflect based on being actuated, wherein deflection of the plurality of actuation beams induces the deflections of the plurality of suspension beams.

### BRIEF DESCRIPTION OF THE DRAWINGS

Implementations are described herein making reference to the appended drawings.

FIG. 1 is a schematic block diagram of a 2D scanning system, according to one or more implementations.

FIGS. 2A and 2B show top views of a MEMS device according to one or more implementations.

FIG. 2C shows a cross-section view of the MEMS device.

FIG. 2D shows an isometric view of the MEMS device as the MEMS device rotates about the first rotation axis.

FIG. 2E shows an isometric view of the MEMS device as the MEMS device rotates about the second rotation axis.

FIGS. 3A-3E show MEMS devices with alternative design configurations.

FIGS. 4A-4F show MEMS devices with alternative design configurations.

FIGS. 5A and 5B show top views of a MEMS device according to one or more implementations.

### DETAILED DESCRIPTION

In the following, details are set forth to provide a more thorough explanation of example implementations. However, it will be apparent to those skilled in the art that these implementations may be practiced without these specific details. In other instances, well-known structures and devices are shown in block diagram form or in a schematic view, rather than in detail, in order to avoid obscuring the implementations. In addition, features of the different implementations described hereinafter may be combined with each other, unless specifically noted otherwise.

Further, equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually interchangeable.

Each of the illustrated x-axis, y-axis, and z-axis is substantially perpendicular to the other two axes. In other words, the x-axis is substantially perpendicular to the y-axis and the z-axis, the y-axis is substantially perpendicular to the x-axis and the z-axis, and the z-axis is substantially perpendicular to the x-axis and the y-axis. In some cases, a single reference number is shown to refer to a surface, or fewer than all instances of a part may be labeled with all surfaces of that part. All instances of the part may include associated surfaces of that part despite not every surface being labeled.

The orientations of the various elements in the figures are shown as examples, and the illustrated examples may be rotated relative to the depicted orientations. The descriptions provided herein, and the claims that follow, pertain to any structures that have the described relationships between various features, regardless of whether the structures are in the particular orientation of the drawings, or are rotated relative to such orientation. Similarly, spatially relative terms, such as “top,” “bottom,” “below,” “beneath,” “lower,” “above,” “upper,” “middle,” “left,” and “right,” are used herein for ease of description to describe one element's relationship to one or more other elements as illustrated in the figures. The spatially relative terms are intended to encompass different orientations of the element, structure, and/or assembly in use or operation in addition to the orientations depicted in the figures. A structure and/or assembly may be otherwise oriented (rotated 90 degrees or at other orientations), and the spatially relative descriptors used herein may be interpreted accordingly. Furthermore, the cross-sectional views in the figures only show features within the planes of the cross-sections, and do not show materials behind the planes of the cross-sections, unless indicated otherwise, in order to simplify the drawings.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling (e.g., any connection or coupling without additional intervening elements) may also be implemented by an indirect connection or coupling (e.g., a connection or coupling with one or more additional intervening elements, or vice versa) as long as the general purpose of the connection or coupling (e.g., to transmit a certain kind of signal or to transmit a certain kind of information) is essentially maintained. Features from different implementations may be combined to form further implementations. For example, variations or modifications described with respect to one of the implementations may also be applicable to other implementations unless noted to the contrary.

As used herein, the terms “substantially” and “approximately” mean “within reasonable tolerances of manufacturing and measurement.” For example, the terms “substantially” and “approximately” may be used herein to account for small manufacturing tolerances or other factors (e.g., within 5%) that are deemed acceptable in the industry without departing from the aspects of the implementations described herein. For example, a resistor with an approximate resistance value may practically have a resistance within 5% of the approximate resistance value. As another example, a signal with an approximate signal value may practically have a signal value within 5% of the approximate signal value.

In the present disclosure, expressions including ordinal numbers, such as “first”, “second”, and/or the like, may modify various elements. However, such elements are not limited by such expressions. For example, such expressions do not limit the sequence and/or importance of the elements. Instead, such expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A microelectromechanical system (MEMS) mirror can be driven about two or more scanning axes for use as a scanning device. Alternatively, two MEMS mirrors driven about a respective scanning axis may be optically coupled to form a scanning system. A MEMS mirror-based light beam scanner is one way to implement image projection technologies and object detection technologies such as Light Detection and Ranging (LIDAR). These technologies may rely on a two-dimensional (2D) scanning pattern, such as a Lissajous scanning pattern, that relies on accurately synchronized scanning axes driven at scanning frequencies that have a fixed frequency ratio.

Resonant MEMS scanning micromirrors show great potential as a key component of future miniaturized projection systems. MEMS scanning micromirrors are microstructured resonators. Thus, MEMS scanning micromirrors feature structural members, such as springs, that function as spring system (e.g., a suspension system) and also feature a rigid mirror body, which is suspended by the suspension system. Together, the springs and the rigid mirror body form a spring-mass system that can be excited in one or several eigenmodes by a suitable actuation mechanism to induce a desired oscillatory motion of the rigid mirror body. Usually, in MEMS the actuation mechanism is either electrostatic (capacitive), piezoelectric, or electromagnetic. For micromirrors implemented in projection applications, desired eigenmodes are two perpendicular rotatory motions of the rigid mirror body. The rigid mirror body typically has a circular or elliptical surface with high reflectivity, which represents a reflective surface that may also be referred to as a mirror surface. Often, the entire MEMS structure is called a MEMS mirror. When one or two rotatory eigenmodes of the rigid mirror body are excited, in which the rotation axis or axes lie(s) in a plane of the reflective surface, a normal to the plane of the reflective surface will travel in an oscillatory motion in one or two directions. If a light beam of a collimated light source, such as a laser, is directed onto the reflective surface, an angle of incidence will change according to a motion of the normal. The motion of the normal will steer a reflected beam accordingly. If laser beam scanning is performed in two directions and in a controlled fashion, the reflected beam can be steered at a solid angle with knowledge of current angular coordinates with respect to the normal of the reflective surface at a resting position. If an RGB light source, having three laser diodes forming RGB channels, is pulsed and turned on and off in a controlled fashion according to a current position of the MEMS mirror, a beam scanning system can form a projection apparatus that may project desired image content on a screen.

A performance of the beam scanning system may be defined by at least four key properties of the MEMS mirror, including the frequencies of two operational rotatory eigenmodes in which the MEMS mirror is excited, a diameter of reflective surface of the mirror body, maximum angular amplitudes of the resonant oscillatory motions, to which the two rotatory eigenmodes are excited, and a dynamic deformation of the reflective surface of the mirror body.

The frequencies of the two operational rotatory eigenmodes determine the angular distance, which the trajectories of both scanning axes can travel in a given amount of time. The trajectory of one scanning axis in single operation may be defined by an angle of the reflective surface normal measured versus the normal at the rest position as a function of time. In simultaneous excitation of both axes, the trajectory is a 2D-angle of the reflective surface normal as a function of time measured versus the normal at the rest position. The more angular distance the reflective surface can travel in a given amount of time, the more image content can be projected in the same amount of time. For this reason, the frequencies can be understood to determine a resolution of a projection device.

The MEMS mirror is part of an optical system. For this reason, the mirror body needs a certain diameter in order to avoid unwanted optical effects, such as diffraction.

The maximum angular amplitudes define the solid angle, in which the trajectory of the reflective surface normal travels. Thus, the maximum angular amplitudes define the optical field-of-view of the projection, and thus a size of a projected image at a given distance from the projection device.

The mirror body is not perfectly rigid. Since the mirror body is repeatedly accelerated and decelerated in resonant motions, the mirror body will deform under its own inertia. This is called dynamic deformation. Dynamic deformation deteriorates an optical projection quality because the reflective surface will not be a perfect plane, but will instead have surface regions that are out-of-plane (e.g., curved or otherwise deformed from being straight).

A challenge in designing MEMS mirrors is therefore to make the mirror body as rigid as possible while reducing an inertia or mass of the mirror body in order to reduce the dynamic deformation and yield a better projection quality. At the same time, this process often also reduces the moments of inertia associated with the two rotatory eigenmodes. Reduction of inertia leads to higher frequencies, and thus higher resolution. Alternatively, the reduction in inertia can be leveraged to reduce mechanical stress in the suspension system. For example, a basic relation of frequency f, spring constant k, and inertia I associated with a certain mode can be expressed by the following equation 2πf=√(k/I). A reduction in inertia allows a reduction of the spring constant, when a constant frequency is desired. A reduction of the spring constant can usually be translated into a reduction of maximum mechanical stress appearing in the suspension system during the oscillation, which may improve the reliability of the MEMS mirror and/or will allow for higher maximum angular amplitudes.

Achieving large field-of-view and resolution with laser beam scanning technology using 2D MEMS scanning requires MEMS mirrors to have a very high resonance frequency (bi-resonant) and reach high mechanical angles (e.g., angles greater than 10°). The 2D MEMS mirror should also be driven with precise frequency ratio, or frequency difference, between two operational modes. The operational modes correspond to oscillations about two scanning axes (e.g., two rotation axes), respectively. Thus, the 2D MEMS mirror should also be driven such that oscillation frequencies of the 2D MEMS mirror about the two scanning axes are maintained at a precise frequency ratio.

Some implementations disclosed herein are directed to a suspension assembly and an outer actuation system assembly for a MEMS mirror (e.g., a micro-mirror). For example, the MEMS mirror may be embedded in the suspension assembly and the outer actuation system assembly. The outer actuation system assembly may include a ring structure and outer actuation segments that are used for piezoelectric actuation and controlling of oscillations of the MEMS mirror about two rotation axes. The outer actuation segments may enable tuning of oscillation frequencies of two operational modes to the desired fixed frequency ratio, while having sufficiently low stresses in the suspension assembly to reach high tilt amplitudes (e.g., tilt amplitudes that are greater than 10°).

In some implementations, a MEMS device includes of a mirror system, an inner suspension system (acting as spring elements), an outer actuation system, and a frame. The inner suspension system and the outer actuation system each include several parts that provide different functions and serve different purposes.

The mirror system may include micro mirror (e.g., a mirror body) that can be supported by a stiffening structure. The micro mirror may be is anchored to a connector system, such as a connector ring, by two or more connectors. Together, the micro mirror and the connector system form the mirror system.

The inner suspension assembly is connected to the connector system by two inner torsion beams. The two inner torsion beams are aligned with a first rotation axis (e.g., a fast axis), which defines a horizontal symmetry plane of the MEMS device. The inner torsion beams are connected to two outer torsion beams by a linkage system that include a plurality of linkages or suspension beams. The two outer torsion beams are aligned with a second rotation axis (e.g., a slow axis), which defines a vertical symmetry plane of the MEMS device. The shape of the inner and the outer torsion beams (e.g., width, length), and, especially, radial fillets of adjacent parts in the linkage system, may be designed such that mechanical stress is distributed in order to allow high oscillation amplitudes for both operational modes, and, at the same time, such that the desired operational frequencies of the micro mirror can be reached. The shape of the linkages of the linkage system may be designed such that the mechanical stress is distributed along the linkages. The shape of the inner and the outer torsion beams and the linkages should be done such that the mechanical stress maxima of the two operational modes are not located in the same area, since that would drastically lower the reachable amplitudes. As a result of the shape of the inner and the outer torsion beams and the linkages, the two operational modes are widely decoupled from each other.

The outer actuation assembly may include an inner actuation ring that is used to actuate the mirror system along a vertical symmetry axis by means of piezoelectric electrodes that are placed on the inner actuation ring. The outer actuation assembly may also include outer actuation segments are connected to the inner actuation ring by actuator connection segments. Piezoelectric electrodes may be arranged on the outer actuation segments in order to actuate the mirror system along a horizontal axis of symmetry. In addition, both actuation parts (e.g., the inner actuation ring and the outer actuation segments) may include piezoelectric sensing electrodes that may be used for sensing and for controlling an operation of the mirror oscillations.

Out-of-phase modes may be used for the oscillations of the micro mirror. As a result, the inner actuation ring may deflect in opposite directions relative to the mirror system itself for the oscillation around the second rotation axis. Similarly, for the oscillation around the first rotation axis, the outer actuation segments may deflect in opposite directions relative to the mirror system. The advantage of placing the actuation electrodes on the outer actuation assembly (and not placing the actuation electrodes directly on the suspension assembly) is that the outer actuation assembly undergoes lower mechanical stress relative to the suspension assembly. Thus, the actuation electrodes are placed on lower mechanical stress areas, which reduces a likelihood that the actuation electrodes will break, and therefore may extend a lifetime of the MEMS device. By using the out-of-phase modes, high oscillation frequencies can be preserved.

In addition, the inner actuation ring may be shaped such that absolute deflections of the inner actuation ring is as small as possible compared to deflections of the mirror system. As a result, mechanical stress in fillets connecting the outer torsion beams with the inner actuation ring may be reduced. Limiting the deflections of the inner actuation ring may be achieved by increasing the inertia of the inner actuation ring (e.g., by increasing a width of the inner actuation ring) compared to the inertia of the mirror system. At the same time, the operational frequencies may be kept constant based on a shape of the outer torsion beams (e.g., by increasing a width or decreasing a length of the outer torsion beams).

A stiffness of the outer actuation segments may be used to tune the frequency of the oscillation around the first rotation axis (e.g., by a variation of the length of the actuation segments). In other words, the frequency of the oscillation around the first rotation axis may be designed based on a variation of a position of a frame connection of the outer actuation segments to the frame.

In some implementations, other types of torsional springs may be used, such as V-shaped springs or two torsion beams in place of one torsion beam.

According to a side view or a cross-section view of the MEMS deice, the mirror body may be formed by a first layer having a layer thickness between 5-25 μm, the suspension assembly and the outer actuation system assembly may be formed by the first layer and a second layer, with a total thickness between 60-140 μm, and the stiffening structure may be formed by the second layer and a third layer, with a total thickness between 150-400 μm. The stiffening structure may have a relatively large thickness to ensure stability of the MEMS mirror with low dynamic deformation

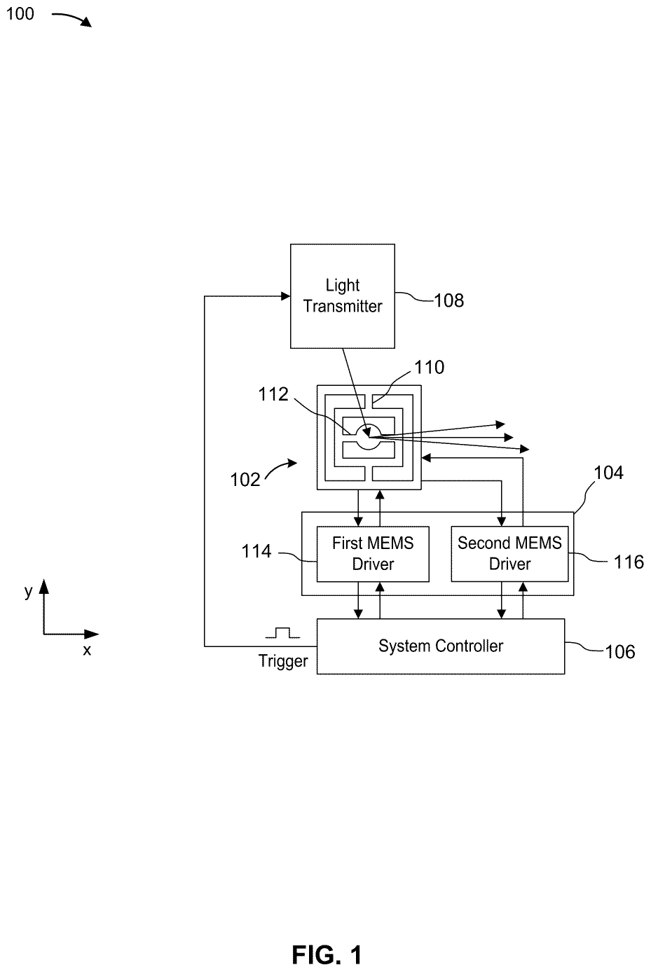

FIG. 1 is a schematic block diagram of a 2D scanning system 100, according to one or more implementations. In particular, the 2D scanning system 100 includes a microelectromechanical system (MEMS) mirror 102 implemented as a single scanning structure that is configured to steer or otherwise deflect light beams according to a 2D scanning pattern. The 2D scanning system 100 further includes a MEMS driver system 104, a system controller 106, and a light transmitter 108.

In the example shown in FIG. 1, the MEMS mirror 102 is a mechanical moving mirror (e.g., a MEMS micro-mirror) integrated on a semiconductor chip (not shown). The MEMS mirror 102 is configured to rotate or oscillate via rotation about two scanning axes (e.g., two rotation axes) that are typically orthogonal to each other. For example, the two scanning axes may include a first scanning axis 110 (e.g., an outer scanning axis) that enables the MEMS mirror 102 to steer light in a first scanning direction (e.g., an x-direction) and a second scanning axis 112 (e.g., an inner scanning axis) that enables the MEMS mirror 102 to steer light in a second scanning direction (e.g., a y-direction). As a result, the MEMS mirror 102 can direct light beams in two dimensions according to the 2D scanning pattern and may be referred to as a 2D MEMS mirror.

The MEMS mirror 102 may include a mirror body (e.g., a mirror plate) that has a reflective surface for reflecting light. For example, a reflective layer may be arranged on an upper surface of the mirror body to form the reflective surface. The mirror body may be attached to a suspension assembly by, for example, suspension structures, such as one or more pairs suspension beams. A pair of suspension beams may extend along a respective scanning axis for attaching the mirror plate to a rotationally fixed frame. The suspension beams of a pair of suspension beams may be arranged on opposite sides of the mirror body. The suspension system suspends the mirror body over a cavity to provide the mirror body with sufficient clearance to rotate about the two scanning axes. Thus, the suspension assembly enables rotation of the mirror body about the two scanning axes.

A scan can be performed to illuminate an area referred to as a field-of-view. The scan, such as an oscillating horizontal scan (e.g., from left to right and right to left of a field-of-view), an oscillating vertical scan (e.g., from bottom to top and top to bottom of a field-of-view), or a combination thereof (e.g., a Lissajous scan or a raster scan) can illuminate the field-of-view in a continuous scan fashion. In some implementations, the 2D scanning system 100 may be configured to transmit successive light beams (e.g., as successive light pulses) in different scanning directions to scan the field-of-view. In some implementations, the 2D scanning system 100 may be configured to transmit a continuous light beam (e.g., as a frequency-modulated continuous-wave (FMCW)) in different scanning directions to scan the field-of-view. In other words, the field-of-view can be illuminated by a scanning operation. In general, an entire field-of-view represents a scanning area defined by a full range of motion of the MEMS mirror 102 at which the MEMS mirror 102 is driven. Thus, the entire field-of-view is delineated by a left edge, a right edge, a bottom edge, and a top edge. The entire field-of-view can also be referred to as a field of illumination or as a projection area in a projection plane onto which an image is projected.

The MEMS mirror 102 can direct a transmitted light beam at a desired 2D coordinate (e.g., an x-y coordinate) in the field-of-view. In some implementations, such as Light Detection and Ranging (LIDAR), the MEMS mirror 102 may be arranged to receive transmitted light beams from the light transmitter 108 and steer (scan) the transmitted light beams into the field-of-view to perform a scanning of the environment. The transmitted light beams may be backscattered by one or more objects back toward the 2D scanning system 100A as reflected light beams, where the reflected light beams are detected by a sensor. For example, the sensor may be a photodetector array. The sensor may convert each reflected light beam into an electric signal (e.g., a current signal or a voltage signal) that may be further processed by the 2D scanning system 100A to generate object data or an image. In such implementations, the desired 2D coordinate may correspond to a particular transmission direction in the field-of-view that is targeted by the transmitted light beam for object detection, with different 2D coordinates corresponding to different transmission directions.

Alternatively, in some implementations, such as image projection systems, the desired 2D coordinate may correspond to an image pixel of a projected image, with different 2D coordinates corresponding to different image pixels of the projected image. In some implementations, an image projection system may include wearable augmented reality goggles and the MEMS mirror 102 may be arranged to receive the transmitted light beams and steer (scan) the transmitted light beams onto a retina of a human eye in order to render an image thereon. In some implementations, an image projection system may include a head-up display (HUD) and the MEMS mirror 102 may be arranged to receive the transmitted light beams and steer (scan) the transmitted light beams onto a display screen.

Accordingly, multiple light beams transmitted at different transmission times or a continuous light beam can be steered by the MEMS mirror 102 at the different 2D coordinates of the field-of-view in accordance with the 2D scanning pattern. The MEMS mirror 102 can be used to scan the field-of-view in both scanning directions by changing an angle of deflection of the MEMS mirror 102 on each of the first scanning axis 110 and the second scanning axis 112.

A rotation of the MEMS mirror 102 on the first scanning axis 110 may be performed between two predetermined extremum deflection angles (e.g., +/−5 degrees, +/−15 degrees, etc.). Likewise, a rotation of the MEMS mirror 102 on the second scanning axis 112 may be performed between two predetermined extremum deflection angles (e.g., +/−5 degrees, +/−15 degrees, etc.). In some implementations, depending on the 2D scanning pattern, the two predetermined extremum deflection angles used for the first scanning axis 110 may be the same as the two predetermined extremum deflection angles used for the second scanning axis 112. In some implementations, depending on the 2D scanning pattern, the two predetermined extremum deflection angles used for the first scanning axis 110 may be different from the two predetermined extremum deflection angles used for the second scanning axis 112.

In some implementations, the MEMS mirror 102 can be a resonator (e.g., a resonant MEMS mirror) configured to oscillate side-to-side about the first scanning axis 110 at a first frequency (e.g., a first resonance frequency) and configured to oscillate top-to-bottom about the second scanning axis 112 at a second frequency (e.g., a second resonance frequency). Thus, the MEMS mirror 102 can be continuously driven about the first scanning axis 110 and the second scanning axis 112 to perform a continuous scanning operation. As a result, light beams reflected by the MEMS mirror 102 are scanned into the field-of-view in accordance with the 2D scanning pattern.

Different frequencies or a same frequency may be used for the first scanning axis 110 and the second scanning axis 112 for defining the 2D scanning pattern. For example, a raster scanning pattern or a Lissajous scanning pattern may be achieved by using different frequencies for the first frequency and the second frequency. Raster scanning and Lissajous scanning are two types of scanning that can be implemented in display applications, light scanning applications, and light steering applications, to name a few. As an example, Lissajous scanning is typically performed using two resonant scanning axes which are driven at different constant scanning frequencies with a defined fixed frequency ratio therebetween that forms a specific Lissajous pattern and frame rate. In order to properly carry out the Lissajous scanning or the raster scanning, synchronization of the two scanning axes is performed by the system controller 106 in conjunction with transmission timings of the light transmitter 108.

For each respective scanning axis, including the first scanning axis 110 and the second scanning axis 112, the MEMS mirror 102 includes an actuator structure used to drive the MEMS mirror 102 about the respective scanning axis. Each actuator structure may include interdigitated finger electrodes made of interdigitated mirror combs and frame combs to which a drive voltage (e.g., an actuation signal or driving signal) is applied by the MEMS driver system 104. Applying a difference in electrical potential between interleaved mirror combs and frame combs creates a driving force between the mirror combs and the frame combs, which creates a torque on the mirror body of the MEMS mirror 102 about the intended scanning axis. The drive voltage can be toggled between two voltages, resulting in an oscillating driving force. The oscillating driving force causes the MEMS mirror 102 to oscillate back and forth on the respective scanning axis between two extrema. Depending on the configuration, this actuation can be regulated or adjusted by adjusting a drive voltage off time, a voltage level of the drive voltage (e.g., a high-voltage (HV) level), or a duty cycle.

In other examples, the MEMS mirror 102 may use other actuation methods to drive the MEMS mirror 102 about the respective scanning axes. For example, these other actuation methods may include electromagnetic actuation and/or piezoelectric actuators. In electromagnetic actuation, the MEMS mirror 102 may be immersed in a magnetic field and an alternating electric current through conductive paths may create the oscillating torque around the scanning axis. Piezoelectric actuators may be integrated in leaf springs of the MEMS mirror 102, or the leaf springs may be made of piezoelectric material to produce alternating beam bending forces in response to an electrical signal to generate the oscillation torque.

The MEMS driver system 104 may be configured to generate driving signals (e.g., actuation signals) to drive the MEMS mirror 102 about the first scanning axis 110 and the second scanning axis 112. In particular, the MEMS driver system 104 may be configured to apply the driving signals to the actuator structure of the MEMS mirror 102. In some implementations, the MEMS driver system 104 includes a first MEMS driver 114 configured to drive the MEMS mirror 102 about the first scanning axis 110 and a second MEMS driver 116 configured to drive the MEMS mirror 102 about the second scanning axis 112. In implementations in which the MEMS mirror 102 is used as an oscillator, the first MEMS driver 114 is configured to drive an oscillation of the MEMS mirror 102 about the first scanning axis 110 at the first frequency, and the second MEMS driver 116 is configured to drive an oscillation of the MEMS mirror 102 about the second scanning axis 112 at the second frequency.

The first MEMS driver 114 may be configured to sense an outer axis movement (e.g., a first rotational position) of the MEMS mirror 102 about the first scanning axis 110 using an outer axis sensor and provide first position information indicative of the first rotational position (e.g., tilt angle or degree of rotation about the first scanning axis 110) to the system controller 106. Similarly, the second MEMS driver 116 may be configured to sense an inner axis movement (e.g., a second rotational position) of the MEMS mirror 102 about the second scanning axis 112 using an inner axis sensor and provide second position information indicative of the second rotational position (e.g., tilt angle or degree of rotation about the second scanning axis 112) to the system controller 106.

The system controller 106 may use the first position information and the second position information to trigger light beams at the light transmitter 108. For example, the system controller 106 may use the first position information and the second position information to set a transmission time of light transmitter 108 in order to target a particular 2D coordinate of the 2D scanning pattern. Thus, a higher accuracy in position sensing of the MEMS mirror 102 by the first MEMS driver 114 and the second MEMS driver 116 may result in the system controller 106 providing more accurate and precise control of other components of the 2D scanning system 100.

As noted above, the first MEMS driver 114 and the second MEMS driver 116 may apply a drive voltage to a corresponding actuator structure of the MEMS mirror 102 as the driving signal to drive a rotation (e.g., an oscillation) of the MEMS mirror 102 about a respective scanning axis (e.g., the first scanning axis 110 or the second scanning axis 112). The drive voltage can be switched or toggled between an HV level and a low-voltage (LV) level resulting in an oscillating driving force. In some implementations, the LV level may be zero (e.g., the drive voltage is off), but is not limited thereto and could be a non-zero value. When the drive voltage is toggled between an HV level and an LV level, and the LV level is set to zero, it can be said that the drive voltage is toggled on and off (HV on/off). The oscillating driving force causes the MEMS mirror 102 to oscillate back and forth on the first scanning axis 110 or the second scanning axis 112 between two extrema. The drive voltage may be a constant drive voltage, meaning that the drive voltage is the same voltage when actuated (e.g., toggled on), or one or both of the HV level or the LV level of the drive voltage may be adjustable. However, it will be understood that the drive voltage is being toggled between the HV level and the LV level in order to produce the mirror oscillation. Depending on a configuration, this actuation can be regulated or adjusted by the system controller 106 by adjusting the drive voltage off time, a voltage level of the drive voltage, or a duty cycle. As noted above, frequency and phase of the drive voltage can also be regulated and adjusted.

In some implementations, the system controller 106 is configured to set a driving frequency of the MEMS mirror 102 for each scanning axis and is capable of synchronizing the oscillations about the first scanning axis 110 and the second scanning axis 112. In particular, the system controller 106 may be configured to control an actuation of the MEMS mirror 102 about each scanning axis by controlling the driving signals. The system controller 106 may control the frequency, the phase, the duty cycle, the HV level, and/or the LV level of the driving signals to control the actuations about the first scanning axis 110 and the second scanning axis 112. The actuation of the MEMS mirror 102 about a particular scanning axis controls its range of motion and scanning rate about that particular scanning axis.

For example, to make a Lissajous scanning pattern reproduce itself periodically with a frame rate frequency, the first frequency at which the MEMS mirror 102 is driven about the first scanning axis 110 and the second frequency at which the MEMS mirror 102 is driven about the second scanning axis 112 are different. A difference between the first frequency and the second frequency is set by a fixed frequency ratio that is used by the 2D scanning system 100 to form a repeatable Lissajous pattern (frame) with a frame rate. A new frame begins each time the Lissajous scanning pattern restarts, which may occur when a phase difference between a mirror phase about the first scanning axis 110 and a mirror phase about the second scanning axis 112 is zero. The system controller 106 may set the fixed frequency ratio and synchronize the oscillations about the first scanning axis 110 and the second scanning axis 112 to ensure that this fixed frequency ratio is maintained based on the first position information and the second position information received from the first MEMS driver 114 and the second MEMS driver 116, respectively.

The light transmitter may include one or more light sources, such as one or more laser diodes or one or more light emitting diodes, for generating one or more light beams. In some implementations, the light transmitter 108 may be configured to sequentially transmit a plurality of light beams (e.g., light pulses) as the MEMS mirror 102 changes its transmission direction in order to target different 2D coordinates. The plurality of light beams may include visible light, infrared (IR) light, or other types of illumination signals, depending on an application of the 2D scanning system 100. A transmission sequence of the plurality of light beams and a timing thereof may be implemented by the light transmitter 108 according to a trigger signal received from the system controller 106. Alternatively, in some implementations, the light transmitter 108 may be configured to transmit a continuous light beam as the MEMS mirror 102 changes its transmission direction in order to target different 2D coordinates. The continuous light beam may include visible light, IR light, or another type of illumination signal, depending on the application of the 2D scanning system 100.

The system controller 106 is configured to control components of the 2D scanning system 100. In certain applications, the system controller 106 may also be configured to receive programming information with respect to the 2D scanning pattern and control a timing of the plurality of light beams generated by the light transmitter 108 based on the programming information. Thus, the system controller 106 may include both processing and control circuity that is configured to generate control signals for controlling the light transmitter 108, the first MEMS driver 114, and the second MEMS driver 116.

In some implementations, the system controller 106 is configured to use independent measurements of the outer axis movement about the first scanning axis 110 and the inner axis movement about the second scanning axis 112 to drive and correctly synchronize transmission timings of the plurality of light beams with the movements of the MEMS mirror 102 and to synchronize a first scanning frequency of the first scanning axis 110 and a second scanning frequency of the second scanning axis 112. For example, the system controller 106 may be configured to set the driving frequencies of the MEMS mirror 102 for the first scanning axis 110 and the second scanning axis 112, and may be capable of synchronizing the oscillations about the first scanning axis 110 and the second scanning axis 112 to generate the 2D scanning pattern. In some implementations, in which the plurality of light beams is used, the system controller 106 may be configured to generate the trigger signal used for triggering the light transmitter 108 to generate the plurality of light beams. Using the trigger signal, the system controller 106 can control the transmission times of the plurality of light beams of the light transmitter 108 to achieve a desired illumination pattern within the field-of-view. The desired illumination pattern is produced by a combination of the 2D scanning pattern produced by the MEMS mirror 102 and the transmission times triggered by the system controller 106. In some implementations in which the continuous light beam is used, the system controller 106 may be configured to control a frequency modulation of the continuous light beam via a control signal provided to the light transmitter 108.

As indicated above, FIG. 1 is provided as an example. Other examples may differ from what is described with regard to FIG. 1. In practice, the 2D scanning system 100 may include additional components, fewer components, different components, or differently arranged components than those shown in FIG. 1 without deviating from the disclosure provided above. In addition, in some implementations, the 2D scanning system 100 may include one or more additional 2D MEMS mirrors or one or more additional light transmitters used to scan one or more additional field-of-views. Additionally, two or more components shown in FIG. 1 may be implemented within a single component, or a single component shown in FIG. 1 may be implemented as multiple, distributed components. Additionally, or alternatively, a set of components (e.g., one or more components) of the 2D scanning system 100 may perform one or more functions described as being performed by another set of components of the 2D scanning system 100.

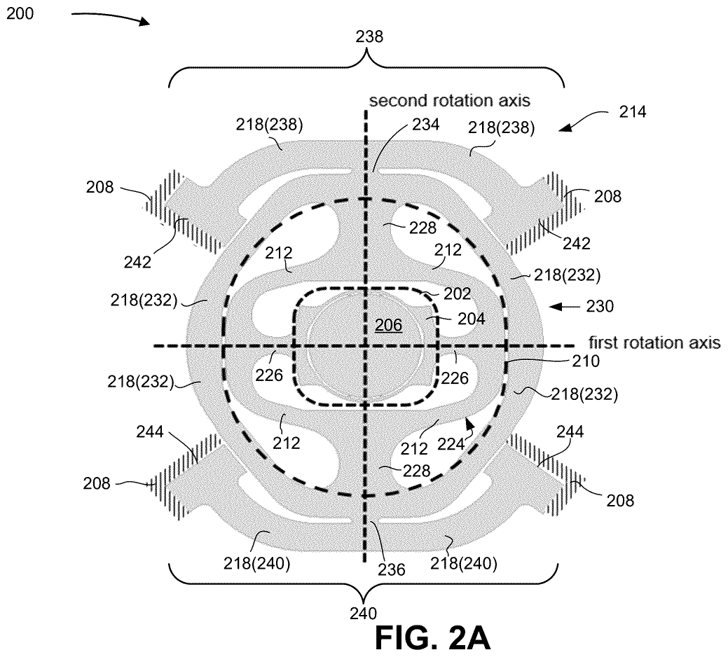

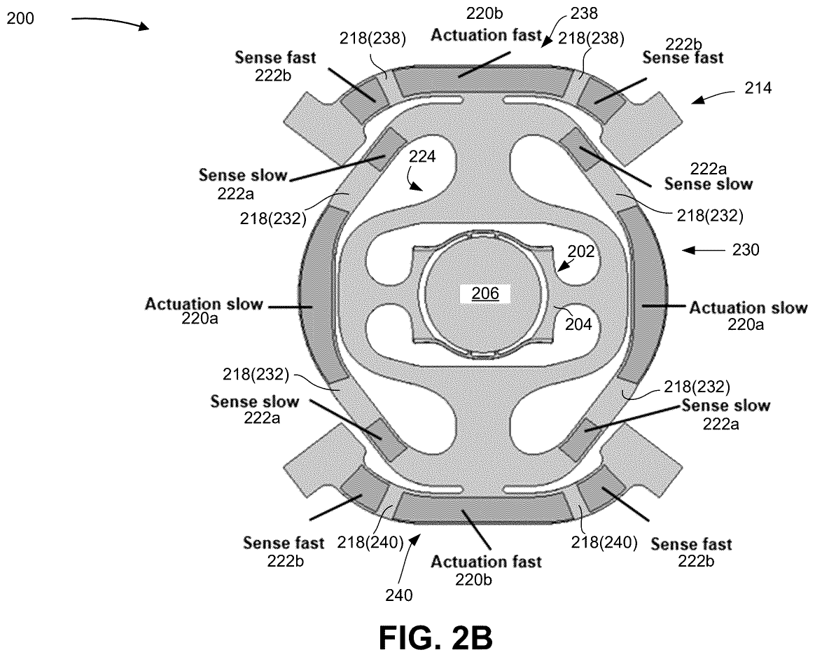

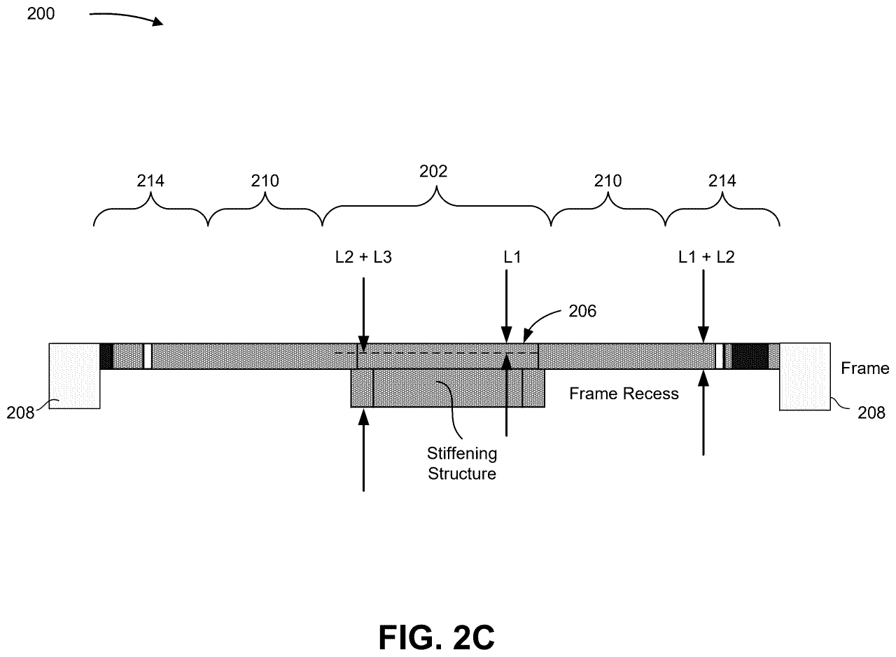

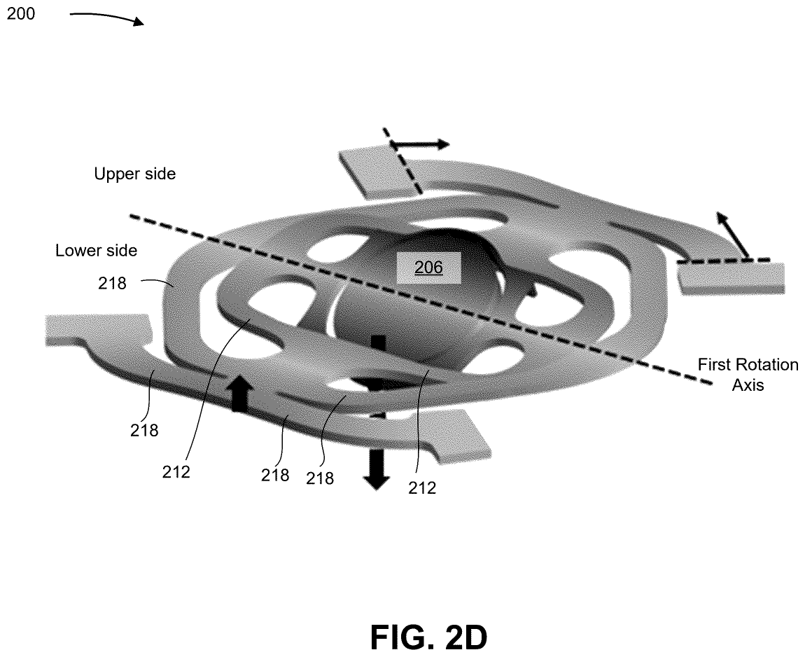

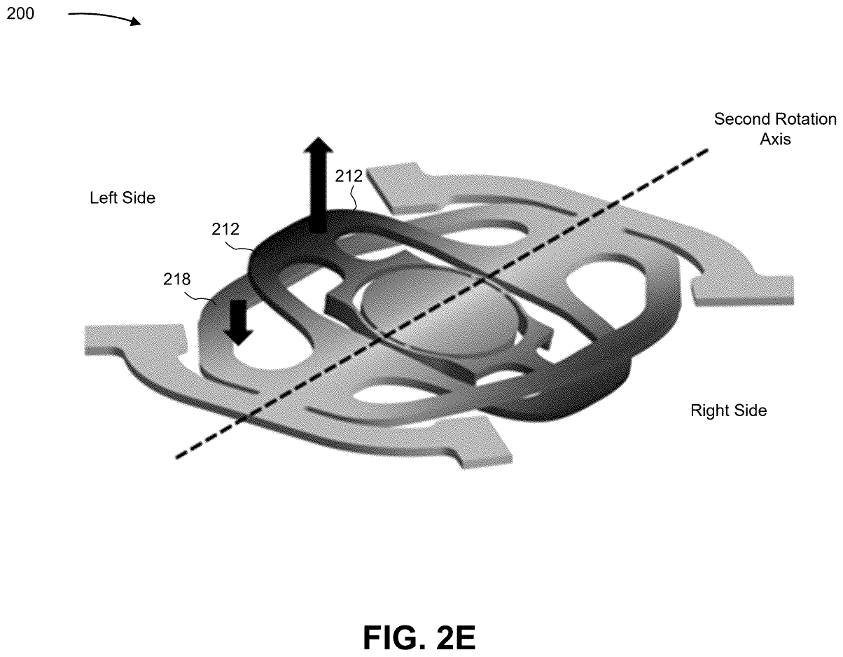

FIGS. 2A and 2B show top views of a MEMS device 200 according to one or more implementations. The MEMS device 200 may be a MEMS mirror device. The MEMS device 200 may include a mirror system 202 including a connector ring 204 and a mirror body 206 coupled to the connector ring 204. The mirror body 206, arranged inside the connector ring 204, is configured to rotate about a first rotation axis (e.g., a fast axis) and to rotate about a second rotation axis (e.g., a slow axis) that is perpendicular to the first rotation axis. The mirror system 202, and consequently the mirror body 206, may oscillate about the first rotation axis at a first frequency and to oscillate about the second rotation axis at a second frequency that is lower than the first frequency. As a result, the first rotation axis may be referred to as the fast axis, and the second rotation axis may be referred to as the slow axis. A frame 208 is provided that is rotationally fixed. The frame 208 may include or otherwise define a frame recess over which the mirror system 202 is suspended.

The MEMS device 200 may further include an inner suspension assembly 210 mechanically coupled to the mirror system 202. The inner suspension assembly 210 may include a plurality of suspension beams 212 configured to suspend the mirror system 202 over the frame recess. The plurality of suspension beams 212 enable the mirror system 202 to rotate about the first rotation axis and to rotate about the second rotation axis.

The MEMS device 200 may further include an outer actuation system assembly 214 coupled to and between the inner suspension assembly 210 and the frame 208. The outer actuation system assembly 214 suspends the mirror system 202 and the inner suspension assembly 210 over the frame recess. Moreover, the outer actuation system assembly 214 actuates deflections of the plurality of suspension beams 212 to cause the mirror system 202 to rotate about the first rotation axis and to rotate about the second rotation axis. The outer actuation system assembly 214 may include a plurality of actuation beams 218 and a plurality of piezoelectric actuators 220 coupled to the plurality of actuation beams 218, and the plurality of piezoelectric actuators 220 (e.g., piezoelectric actuators 220a and 220b) are configured to induce deflections of the plurality of actuation beams 218 to actuate the deflections of the plurality of suspension beams 212.

An actuation circuit may be configured to generate actuation signals, and provide the actuation signals to the plurality of piezoelectric actuators 220 to control the deflections of the plurality of actuation beams 218 for actuating rotations of the mirror body 206 about the first rotation axis and the second rotation axis. For example, the actuation circuit may be provided in a MEMS driver system, such as MEMS driver system 104. The first MEMS driver 114 and the second MEMS driver 116 may be configured to generate the actuation signals for actuating the piezoelectric actuators 220 and inducing controlled deformations the plurality of actuation beams 218, where the deformations cause the deflections. In some implementations, a system controller, such as system controller 106 may generate the actuation signals for actuating the piezoelectric actuators 220. Thus, the actuation circuit is electrically coupled to the piezoelectric actuators 220. The actuation circuit may generate the actuation signals to maintain out-of-phase relationships (e.g., counter-directional deflections) between corresponding actuation beams and suspension beams described elsewhere herein.

The MEMS device 200 may further include a plurality of piezoelectric sensors 222 (e.g., piezoelectric sensors 222a and 222b) coupled to the plurality of actuation beams 218. The plurality of piezoelectric sensors 222 may sense the deflections of the plurality of actuation beams 218 and generate corresponding sensor signals. For example, the plurality of piezoelectric sensors 222 may generate electrical signals that are proportional to a sensed deformation. At least one piezoelectric sensor 222 may be arranged on each actuation beam 218. The plurality of piezoelectric sensors 222 may provide the sensor signals to the actuation circuit as feedback information (e.g., deformation information, which may correspond to a rotational position or frequency of the mirror body 206). The actuation circuit may adjust an actuation of the plurality of piezoelectric actuators 220 based on the corresponding sensor signals to regulate movements of the mirror body 206 about the first rotation axis and the second rotation axis. For example, the actuation circuit may adjust an actuation of the plurality of piezoelectric actuators 220 based on the corresponding sensor signals to regulate the deflections of the plurality of actuation beams 218 and to control the rotations of the mirror body 206 about the first rotation axis and the second rotation axis. The actuation circuit may adjust the actuation signals based on the sensor signals in order to maintain a maximum tilt amplitude of the mirror body 206 about each rotation axis and/or to maintain a fixed frequency ratio between oscillation frequencies.

The plurality of actuation beams 218 may deflect out-of-phase with the deflections of the plurality of suspension beams 212 to cause the mirror system 202 to rotate about the first rotation axis and to rotate about the second rotation axis. For example, first actuation beams of the plurality of actuation beams 218 and first suspension beams of the plurality of suspension beams 212 arranged on a same side of the first rotation axis are configured to deflect in counter-directional directions (e.g., opposite rotational directions or out-of-phase directions) to cause the mirror system 202 to rotate about the first rotation axis. Additionally, second actuation beams of the plurality of actuation beams 218 and second suspension beams of the plurality of suspension beams 212 arranged on a same side of the second rotation axis are configured to deflect in counter-directional directions to cause the mirror system 202 to rotate about the second rotation axis. The mirror system 202 may rotate about the first rotation axis counter-directionally to a rotation of the first actuation beams about the first rotation axis, and the mirror system 202 may rotate about the second rotation axis counter-directionally to a rotation of the second actuation beams about the second rotation axis.

The inner suspension assembly 210 may include an inner suspension ring 224 formed by the plurality of suspension beams 212, a pair of inner torsion bars 226, and a pair of outer torsion bars 228. The pair of inner torsion bars 226 are oppositely arranged on the first rotation axis relative to the mirror system 202. In addition, the pair of inner torsion bars 226 may extend along the first rotation axis to connect the connector ring 204 to the inner suspension ring 224. The air of outer torsion bars 228 are oppositely arranged on the second rotation axis relative to the mirror system 202. In addition, the pair of outer torsion bars 228 may extend along the second rotation axis to connect the inner suspension ring 224 to the outer actuation system assembly 214. The pair of inner torsion bars 226 may enable the mirror system 202 to rotate about the first rotation axis, and the pair of outer torsion bars 228 may enable the mirror system 202 to rotate about the second rotation axis.

The outer actuation system assembly 214 may include an inner actuation ring 230 that encircles the inner suspension assembly 210 and is coupled to the pair of outer torsion bars 228. Thus, the inner actuation ring 230 is coupled to the inner suspension assembly 210. The inner actuation ring 230 is formed by a set of inner actuation beams 232 of the plurality of actuation beams 218. The outer actuation system assembly 214 may further include a first torsion connector 234 arranged on the second rotation axis, aligned with the pair of outer torsion bars 228. The outer actuation system assembly 214 may further include a second torsion connector 236 arranged on the second rotation axis opposite the first torsion connector 234 relative to the mirror system 202 and aligned with the pair of outer torsion bars 228. The outer actuation system assembly 214 may further include a first outer actuation segment 238 coupled to the inner actuation ring 230 by the first torsion connector 234, the first outer actuation segment 238 comprising a first pair of outer actuation beams 218 (238) of the plurality of actuation beams 218 that are connected to the frame 208. The outer actuation system assembly 214 may further include a second outer actuation segment 240 coupled to the inner actuation ring 230 by the second torsion connector 236, the second outer actuation segment 240 comprising a second pair of outer actuation beams 218 (240) of the plurality of actuation beams 218 that are connected to the frame 208.

In some implementations, the first pair of outer actuation beams 218 (238) may extend in opposite directions from the second rotation axis and connect to the frame 208 at respective first anchor points 242. The respective first anchor points 242 are arranged at respective angles between the first rotation axis and the second rotation axis. In other words, the respective first anchor points 242 are not located on the first rotation axis or on the second rotation axis. Additionally, the second pair of outer actuation beams 218 (240) may extend in opposite directions from the second rotation axis and connect to the frame 208 at respective second anchor points 244, wherein the respective second anchor points 244 are arranged at respective angles between the first rotation axis and the second rotation axis. In other words, the respective second anchor points 244 are not located on the first rotation axis or on the second rotation axis.

In addition, the first pair of outer actuation beams 218 (238) are symmetric about the second rotation axis, the second pair of outer actuation beams 218 (240) are symmetric about the second rotation axis, and the first pair of outer actuation beams 218 (238) are symmetric with the second pair of outer actuation beams 218 (240) about the first rotation axis. In some implementations, the first pair of outer actuation beams 218 (238) are curved to form a first arc that extends partially around the inner actuation ring 230, and the second pair of outer actuation beams 218 (240) are curved to form a second arc that extends partially around the inner actuation ring 230. Alternatively, in some implementations, the first pair of outer actuation beams 218 (238) are straight and extend parallel to the first rotation axis, and wherein the second pair of outer actuation beams 218 (240) are straight and extend parallel to the first rotation axis.

As described above, the mirror system 202, and thus, the mirror body 206, may oscillate about the first rotation axis at a first frequency and to oscillate about the second rotation axis at a second frequency that is lower than the first frequency. The first frequency may be based on lengths of the first pair of outer actuation beams 218 (238) and lengths of the second pair of outer actuation beams 218 (240).

The plurality of piezoelectric actuators 220 may include a first set of piezoelectric actuators 220a, arranged on the set of inner actuation beams 232 of the inner actuation ring 230, for inducing deflections of the set of inner actuation beams 232 to actuate the mirror system 202 to rotate about the second rotation axis. Additionally, the plurality of piezoelectric actuators 220 may include a second set of piezoelectric actuators 220b, arranged on the first pair of outer actuation beams 218 (238) and the second pair of outer actuation beams 218 (240), for inducing deflections of the first pair of outer actuation beams 218 (238) and the second pair of outer actuation beams 218 (240) to actuate the mirror system 202 to rotate about the first rotation axis.

The plurality of piezoelectric sensors 222 may include a first set of piezoelectric sensors 222a coupled to the set of inner actuation beams 232. The first set of piezoelectric sensors 222a may sense the deflections of the set of inner actuation beams 232 and generate corresponding sensor signals as feedback information for a controller (e.g., for a controller of the actuation circuit). Additionally, the plurality of piezoelectric sensors 222 may include a second set of piezoelectric sensors 222b coupled to the first pair of outer actuation beams 218 (238) and the second pair of outer actuation beams 218 (240). The second set of piezoelectric sensors 222b may sense the deflections of the first pair of outer actuation beams 218 (238) and the second pair of outer actuation beams 218 (240) and generate corresponding sensor signals as feedback information for the controller.

A shape of the inner and the outer torsion beams (e.g., width, length), and, especially, radial fillets of adjacent parts in a linkage system, may be designed such that mechanical stress is distributed in order to allow high oscillation amplitudes for both operational modes, and, at the same time, such that the desired operational frequencies of the mirror system 202 can be reached. The shape of the suspension beams 212 of the inner suspension assembly 210 may be designed such that the mechanical stress is distributed along the suspension beams 212. The shape of the inner and the outer torsion beams 226, 228 and the suspension beams 212 may be designed such that the mechanical stress maxima of the two operational modes are not located in the same area, since that would drastically lower the reachable amplitudes. As a result of the shape of the inner and the outer torsion beams 226, 228 and the suspension beams 212, the two operational modes are widely decoupled from each other.

The inner actuation ring 230 and the outer actuation segments 238 and 240 of the outer actuation system assembly 214 are used for piezoelectric actuation and controlling of oscillations of the mirror body 206 about two rotation axes. The outer actuation segments 238 and 240 may enable tuning of oscillation frequencies of two operational modes to the desired fixed frequency ratio, while having sufficiently low stresses in the inner suspension assembly 210 to reach high tilt amplitudes (e.g., tilt amplitudes that are greater than 10°).

Out-of-phase modes may be used for the oscillations of the mirror body 206. As a result, the inner actuation ring 230 may deflect in opposite directions relative to the mirror system 202 for the oscillation around the second rotation axis. Similarly, for the oscillation around the first rotation axis, the outer actuation segments 238 and 240 may deflect in opposite directions relative to the mirror system 202. The advantage of placing the actuation electrodes on the outer actuation system assembly 214 (and not placing the actuation electrodes directly on the inner suspension assembly 210) is that the outer actuation system assembly 214 undergoes lower mechanical stress relative to the inner suspension assembly 210. Thus, the actuation electrodes are placed on lower mechanical stress areas, which reduces a likelihood that the actuation electrodes will break, and therefore may extend a lifetime of the MEMS device 200. By using the out-of-phase modes, high oscillation frequencies can be preserved.

In addition, the inner actuation ring 230 may be shaped such that absolute deflections of the inner actuation ring 230 is as small as possible compared to deflections of the mirror system 202. As a result, mechanical stress in fillets connecting the outer torsion beams 228 with the inner actuation ring 230 may be reduced. Limiting the deflections of the inner actuation ring 230 may be achieved by increasing the inertia of the inner actuation ring 230 (e.g., by increasing a width of the inner actuation ring 230) compared to the inertia of the mirror system 202. At the same time, the operational frequencies may be kept constant based on a shape of the outer torsion beams 228 (e.g., by increasing a width or decreasing a length of the outer torsion beams 228).

FIG. 2C shows a cross-section view of the MEMS device 200. The MEMS device 200 may be formed by a plurality of layers, including a first layer L1, a second layer L2, and a third layer L3. The plurality of layers may be semiconductor layers, such as silicon layers. A stiffening structure may be arranged underneath the mirror body 206 and is configured to support the mirror body 206. The stiffening structure may add rigidity to the mirror body 206 and reduce dynamic deformation of a reflective surface formed on the mirror body 206. The frame 208 may define a frame recess over which the mirror system 202 is suspended by the suspension assembly 210. The mirror body 206 may be formed by the first layer L1 having a layer thickness between 5-25 μm, the inner suspension assembly 210 and the outer actuation system assembly 214 may be formed by the first layer L1 and the second layer L2, with a total thickness between 60-140 μm, and the stiffening structure may be formed by the second layer L2 and the third layer L3, with a total thickness between 150-400 μm. The stiffening structure may have a relatively large thickness to ensure stability of the MEMS mirror with low dynamic deformation.

As indicated above, FIG. 2C is provided as an example. Other examples may differ from what is described with regard to FIG. 2C.

FIG. 2D shows an isometric view of the MEMS device 200 as the MEMS device 200 rotates about the first rotation axis. The first rotation axis may delineate an upper side and a lower side of the MEMS device 200. First actuation beams of the plurality of actuation beams 218 and first suspension beams of the plurality of suspension beams 212 arranged on a same side of the first rotation axis are configured to deflect in counter-directional directions (e.g., opposite rotational directions or out-of-phase directions) to cause the mirror system 202 to rotate about the first rotation axis. For example, as the actuation beams 218 on the lower side of FIG. 2D deflect upward, the suspension beams 212 on the lower side deflect downward. The portion of the mirror system 202 that is on the lower side also deflects downward. At the same time, the actuation beams 218 on the upper side deflect downward, the suspension beams 212 on the upper side deflect upward, and a portion of the mirror system 202 that is on the upper side also deflects upward. Thus, the mirror system 202 may rotate about the first rotation axis counter-directionally to a rotation of the first actuation beams about the first rotation axis.

As indicated above, FIG. 2D is provided as an example. Other examples may differ from what is described with regard to FIG. 2D.

FIG. 2E shows an isometric view of the MEMS device 200 as the MEMS device 200 rotates about the second rotation axis. The second rotation axis may delineate a left side and a right side of the MEMS device 200. Second actuation beams of the plurality of actuation beams 218 and second suspension beams of the plurality of suspension beams 212 arranged on a same side of the second rotation axis are configured to deflect in counter-directional directions (e.g., opposite rotational directions or out-of-phase directions) to cause the mirror system 202 to rotate about the second rotation axis. For example, as the actuation beams 218 on the left side deflect downward, the suspension beams 212 on the left side deflect upward. The portion of the mirror system 202 that is on the left side also deflects upward. At the same time, the actuation beams 218 on the right side deflect upward, the suspension beams 212 on the right side deflect downward, and a portion of the mirror system 202 that is on the right side also deflects downward. Thus, the mirror system 202 may rotate about the second rotation axis counter-directionally to a rotation of the second actuation beams 218 about the second rotation axis.

As indicated above, FIG. 2E is provided as an example. Other examples may differ from what is described with regard to FIG. 2E.

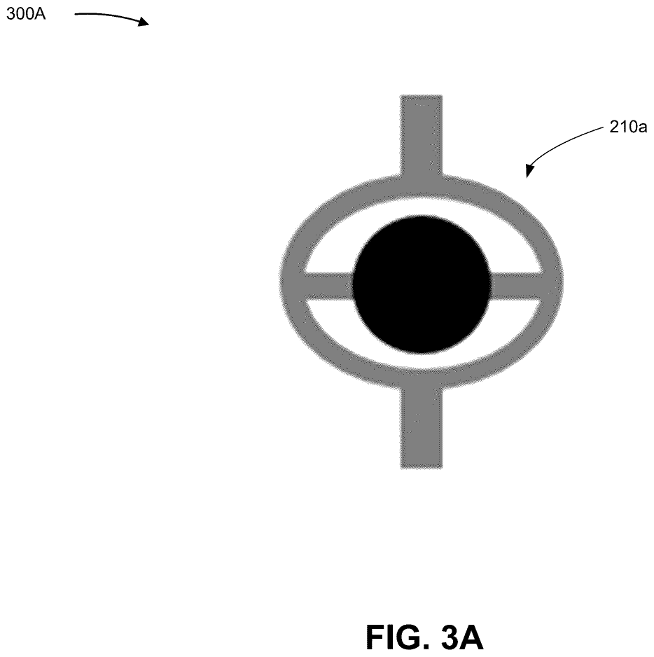

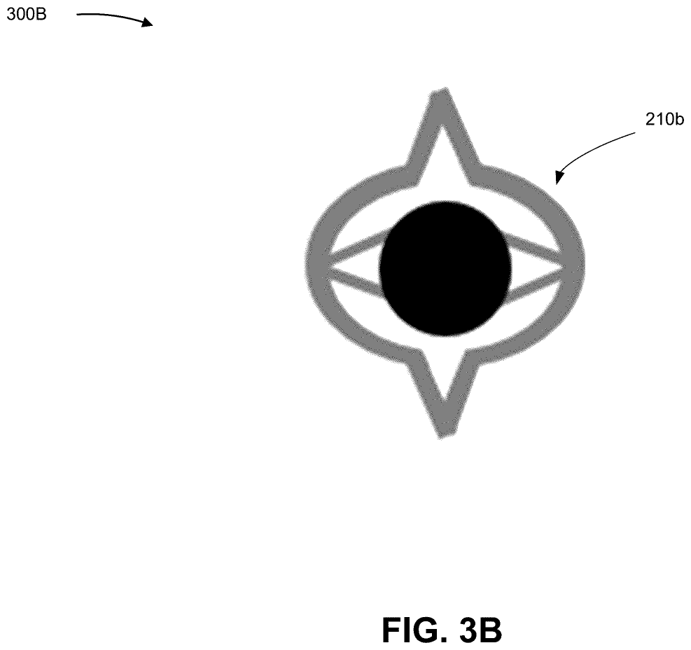

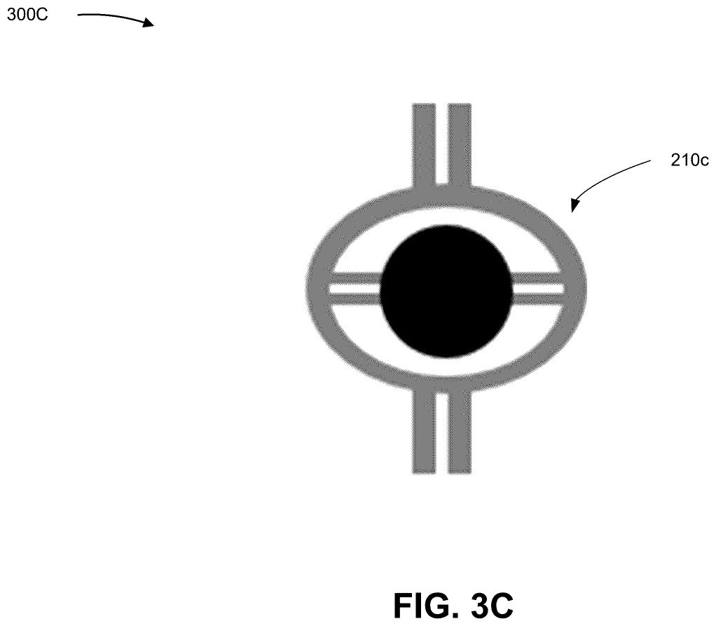

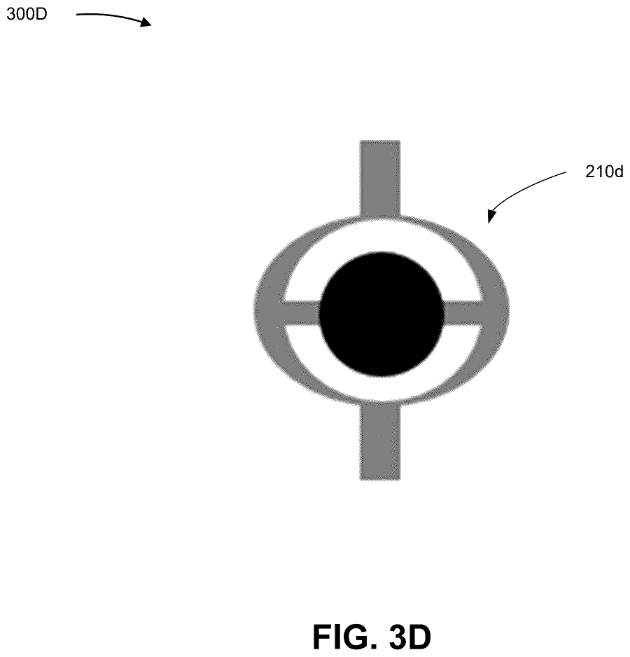

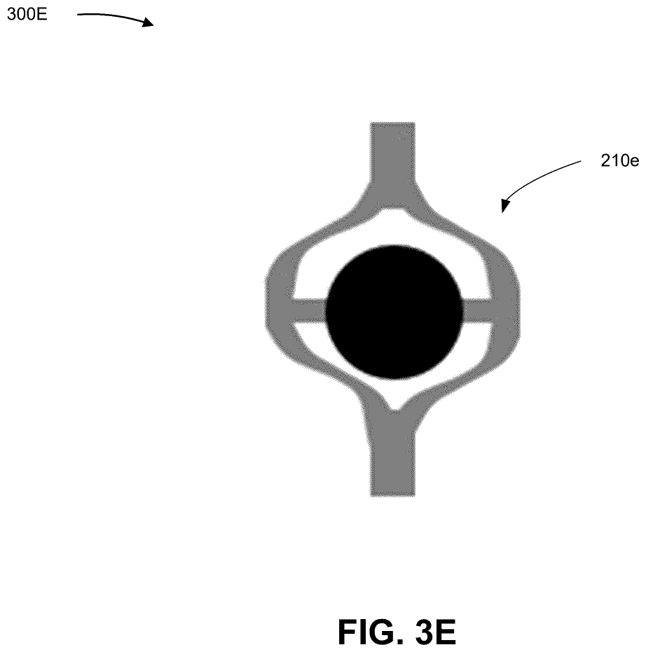

FIGS. 3A-3E show MEMS devices 300A-300E with alternative design configurations. The MEMS devices 300A-300E may be similar to the MEMS device 200 described in connection with FIGS. 2A-2E, except with differently structured inner suspension assemblies 210.

In FIG. 3A, an inner suspension assembly 210a of the MEMS device 300A includes two torsion bar pairs connected by elliptical linkages.

In FIG. 3B, an inner suspension assembly 210b of the MEMS device 300B includes a V-shaped torsion bar for each torsion bar region.

In FIG. 3C, an inner suspension assembly 210c of the MEMS device 300C includes two or more parallel torsion bars for each torsion bar region.

In FIG. 3D, an inner suspension assembly 210d of the MEMS device 300D includes linkages (e.g., suspension beams) with variable widths.

In FIG. 3E, an inner suspension assembly 210e of the MEMS device 300E includes free-shaped linkages (e.g., suspension beams).

As indicated above, FIGS. 3A-3E are provided as examples. Other examples may differ from what is described with regard to FIGS. 3A-3E.

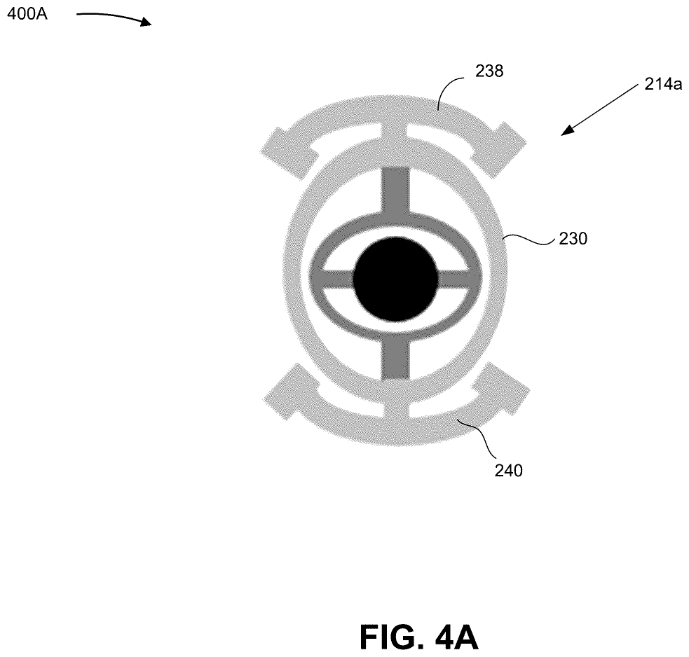

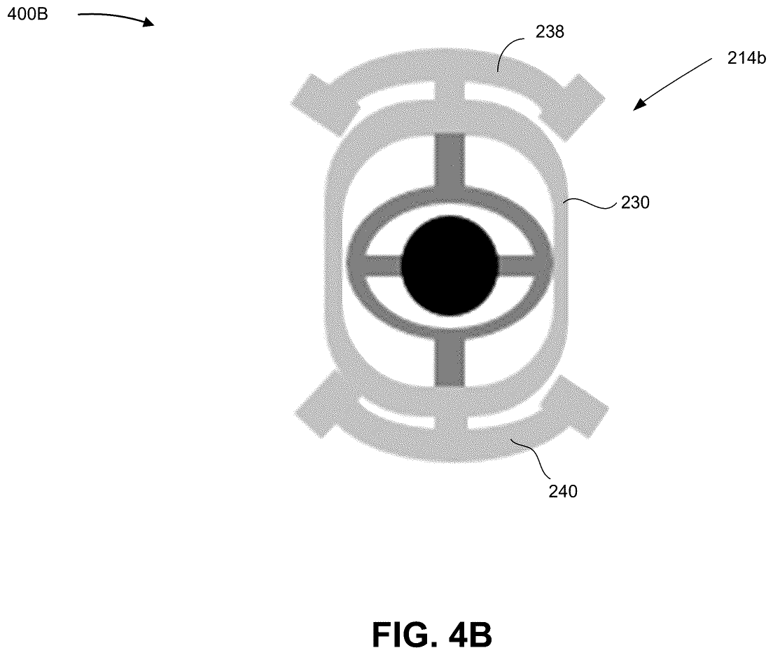

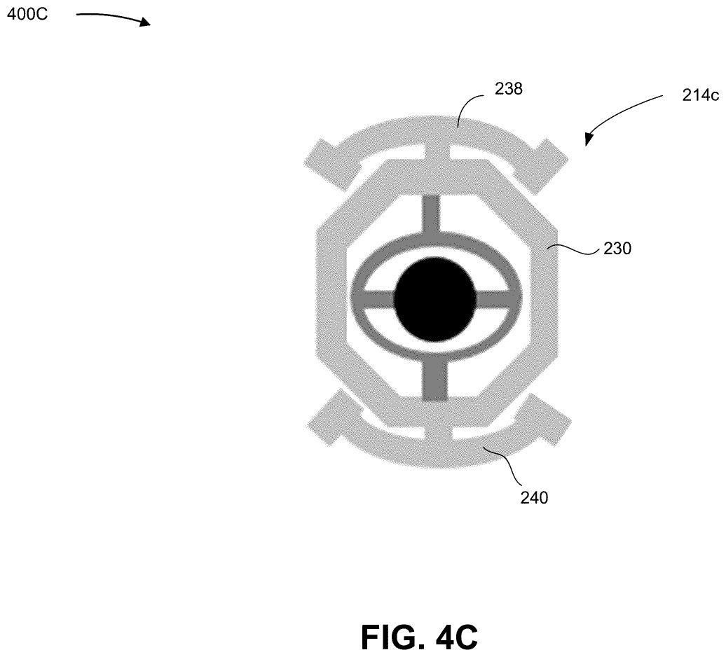

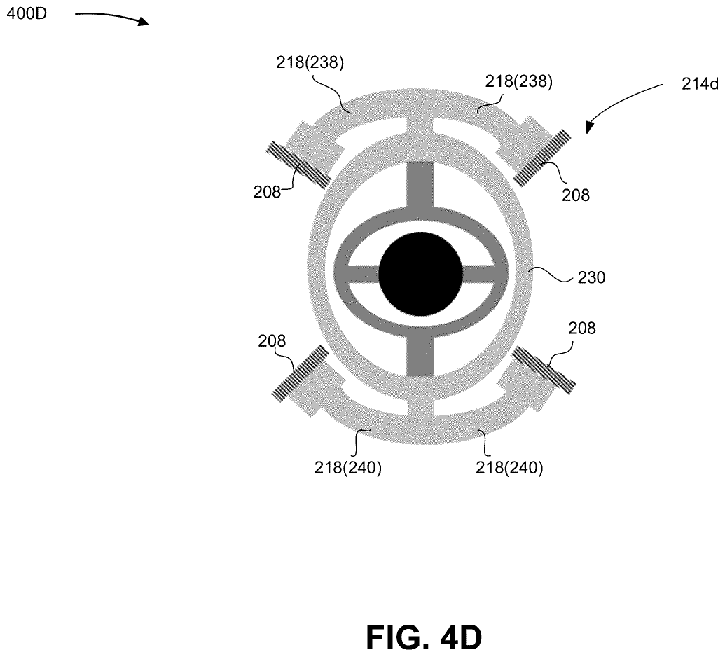

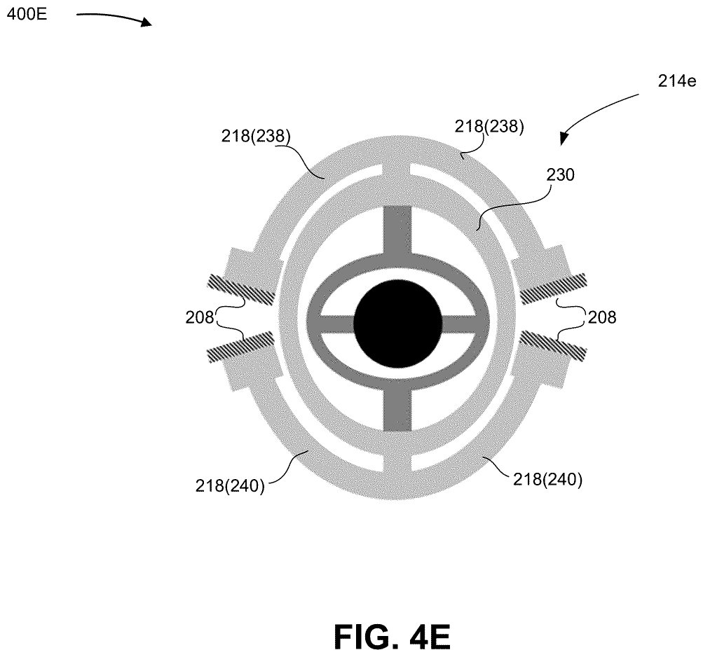

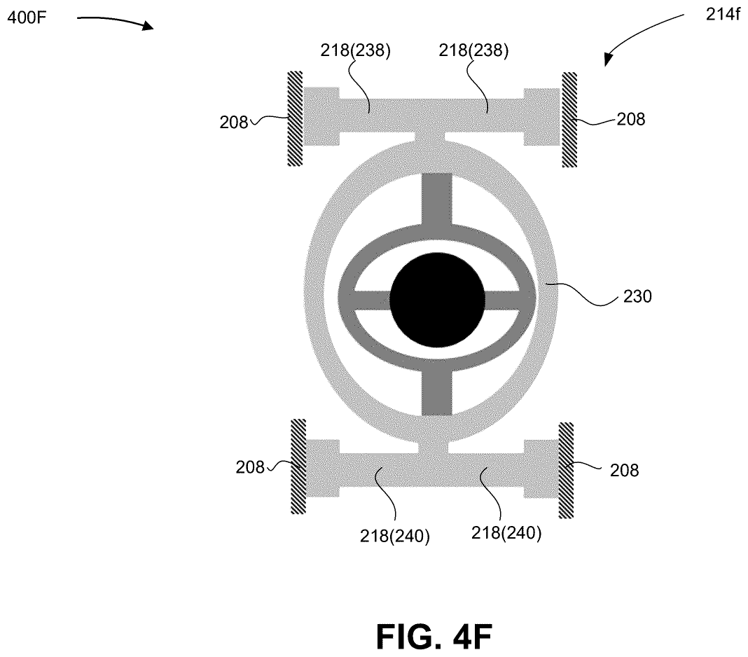

FIGS. 4A-4F show MEMS devices 400A-400F with alternative design configurations. The MEMS devices 400A-400F may be similar to the MEMS device 200 described in connection with FIGS. 2A-2E, except with differently structured outer actuation system assemblies 214.

In FIG. 4A, an outer actuation system assembly 214a of the MEMS device 400A includes an elliptical inner actuation ring 230 (with or without varying width).

In FIG. 4B, an outer actuation system assembly 214b of the MEMS device 400B includes a rectangular-shaped inner actuation ring 230 with rounding at the edges (with or without varying width).

In FIG. 4C, an outer actuation system assembly 214c of the MEMS device 400C includes a polygonial-shaped inner actuation ring 230 (with or without varying width). The polygonial-shaped inner actuation ring 230 may have rounded edges. The polygonial-shaped inner actuation ring 230 may enable an inertia of polygonial-shaped inner actuation ring 230 to be adjusted, and, at the same time, use large fillet radius at an interconectoin of the polygonial-shaped inner actuation ring 230 with the outer torsion beams.

In FIG. 4D, an outer actuation system assembly 214d of the MEMS device 400D includes a first pair of outer actuation beams 218 (238) that are curved to form a first arc that extends partially around the inner actuation ring 230, and a second pair of outer actuation beams 218 (240) that are curved to form a second arc that extends partially around the inner actuation ring 230.

A stiffness of the first pair of outer actuation beams 218 (238) and the second pair of outer actuation beams 218 (240) may be used to tune the frequency (e.g., the first frequency) of the oscillation around the first rotation axis (e.g., by a variation of the length of the outer actuation beams). In other words, the frequency of the oscillation around the first rotation axis may be designed based on a variation of a position of a frame connection of the outer actuation segments to the frame 208. Thus, the first frequency may be based on lengths of the first pair of outer actuation beams 218 (238) and lengths of the second pair of outer actuation beams 218 (240).

In FIG. 4E, an outer actuation system assembly 214e of the MEMS device 400E includes a first pair of outer actuation beams 218 (238) that are curved to form a first arc that extends partially around the inner actuation ring 230, and a second pair of outer actuation beams 218 (240) that are curved to form a second arc that extends partially around the inner actuation ring 230. The outer actuation beams shown in FIG. 4E have longer lengths, and thus a different stiffness, relative to the outer actuation beams shown in FIG. 4D. Thus, the MEMS device 400E will have a different first frequency at which resonance occurs relative to the first frequency of the MEMS device 400D at which resonance occurs.

In FIG. 4F, an outer actuation system assembly 214f of the MEMS device 400F includes a first pair of outer actuation beams 218 (238) that are straight and extend parallel to the first rotation axis, and a second pair of outer actuation beams 218 (240) that are straight and extend parallel to the first rotation axis. Due to a variation in stiffness, the MEMS device 400F will have a different first frequency at which resonance occurs relative to the first frequencies of the MEMS device 400D and the MEMS device 400E at which resonance occurs.

As indicated above, FIGS. 4A-4F are provided as examples. Other examples may differ from what is described with regard to FIGS. 4A-4F.

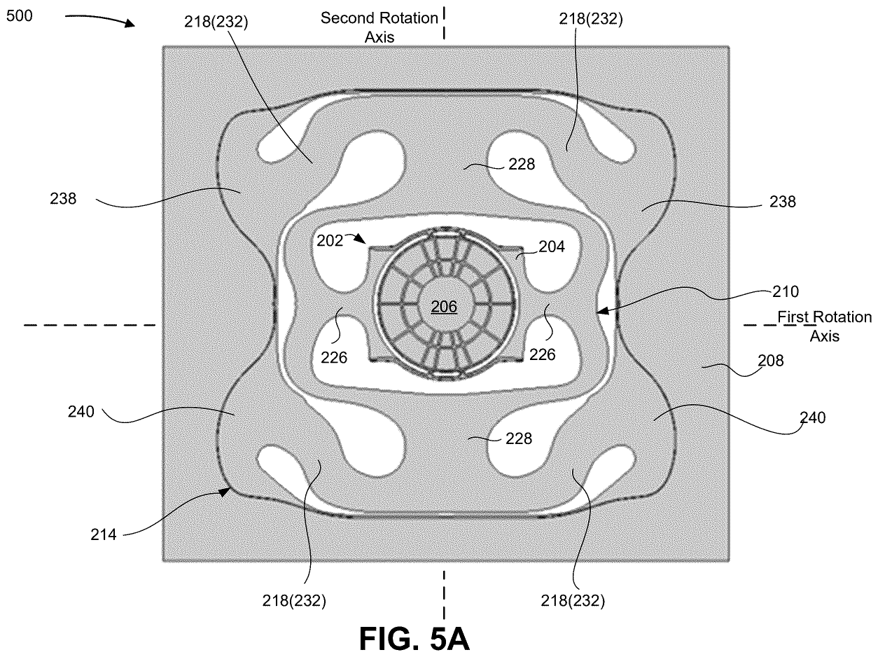

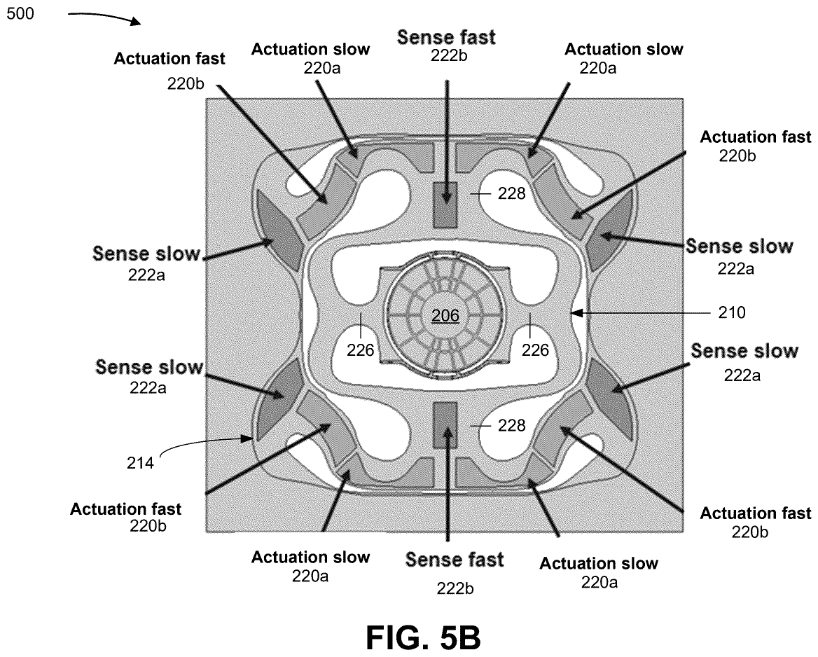

FIGS. 5A and 5B show top views of a MEMS device 500 according to one or more implementations. The MEMS device 500 may be a MEMS mirror device. The MEMS device 500 may be similar to the MEMS device 200 described in connection with FIGS. 2A-2E. However, the set of inner actuation beams 232 of the plurality of actuation beams 218 do not form a full ring, but is instead structured into two partial rings (e.g., a discontinuous actuation ring with two parts). Moreover, each inner actuation beam 232 may be individually coupled to an outer actuation segment, such as outer actuation segment 238 or outer actuation segment 240. Each outer actuation segment 238 and each outer actuation segment 240 is coupled to the frame 208 in a region between the first rotation axis and the second rotation axis. The discontinuous actuation ring may be arranged partially around the inner suspension assembly 210 and is coupled to the pair of outer torsion bars 228, the discontinuous actuation ring being formed by the plurality of actuation beams 218 (232) such that each actuation beam of the plurality of actuation beam is coupled to the frame 208 off-axis from the first rotation axis and the second rotation axis. For example, respective anchor points to the frame 208 are arranged at respective angles between the first rotation axis and the second rotation axis.

The plurality of piezoelectric actuators 220 may include a first set of piezoelectric actuators 220a, arranged on the set of inner actuation beams 232 closer to the second rotation axis, for inducing deflections of the set of inner actuation beams 232 to actuate the mirror system 202 to rotate about the second rotation axis. Additionally, the plurality of piezoelectric actuators 220 may include a second set of piezoelectric actuators 220b, arranged on the set of inner actuation beams 232 closer to the first rotation axis, for inducing deflections of the set of inner actuation beams 232 to actuate the mirror system 202 to rotate about the first rotation axis.

The plurality of piezoelectric sensors 222 may include a first set of piezoelectric sensors 222a coupled to the outer actuation segments 238 and the outer actuation segments 240 for sensing deflections about the second rotation axis. Additionally, the plurality of piezoelectric sensors 222 may include a second set of piezoelectric sensors 222b coupled to the outer torsion beams 228 for sensing deflections about the first rotation axis.

As indicated above, FIGS. 5A and 5B are provided as examples. Other examples may differ from what is described with regard to FIGS. 5A and 5B.

The following provides an overview of some Aspects of the present disclosure:
Aspect 1: A microelectromechanical system (MEMS) device, comprising: a mirror system including a connector ring and a mirror body coupled to the connector ring, wherein the mirror body, arranged inside the connector ring, is configured to rotate about a first rotation axis and to rotate about a second rotation axis that is perpendicular to the first rotation axis; a frame that is rotationally fixed, the frame comprising a frame recess over which the mirror system is suspended; an inner suspension assembly mechanically coupled to the mirror system, the inner suspension assembly comprising a plurality of suspension beams configured to suspend the mirror system over the frame recess, and to enable the mirror system to rotate about the first rotation axis and to rotate about the second rotation axis; and an outer actuation system assembly coupled to and between the inner suspension assembly and the frame, the outer actuation system assembly configured to suspend the mirror system and the inner suspension assembly over the frame recess, and to actuate deflections of the plurality of suspension beams to cause the mirror system to rotate about the first rotation axis and to rotate about the second rotation axis, wherein the outer actuation system assembly includes a plurality of actuation beams and a plurality of piezoelectric actuators coupled to the plurality of actuation beams, and the plurality of piezoelectric actuators are configured to induce deflections of the plurality of actuation beams to actuate the deflections of the plurality of suspension beams.
Aspect 2: The MEMS device of Aspect 1, wherein the plurality of actuation beams are configured to deflect out-of-phase with the deflections of the plurality of suspension beams to cause the mirror system to rotate about the first rotation axis and to rotate about the second rotation axis.
Aspect 3: The MEMS device of any of Aspects 1-2, wherein first actuation beams of the plurality of actuation beams and first suspension beams of the plurality of suspension beams arranged on a same side of the first rotation axis are configured to deflect in counter-directional directions to cause the mirror system to rotate about the first rotation axis, and wherein second actuation beams of the plurality of actuation beams and second suspension beams of the plurality of suspension beams arranged on a same side of the second rotation axis are configured to deflect in counter-directional directions to cause the mirror system to rotate about the second rotation axis.
Aspect 4: The MEMS device of Aspect 3, wherein the mirror system is configured to rotate about the first rotation axis counter-directionally to a rotation of the first actuation beams about the first rotation axis, and wherein the mirror system is configured to rotate about the second rotation axis counter-directionally to a rotation of the second actuation beams about the second rotation axis.
Aspect 5: The MEMS device of any of Aspects 1-4, wherein the mirror system is configured to oscillate about the first rotation axis at a first frequency and to oscillate about the second rotation axis at a second frequency that is lower than the first frequency.
Aspect 6: The MEMS device of any of Aspects 1-5, wherein the inner suspension assembly comprises: an inner suspension ring formed by the plurality of suspension beams; a pair of inner torsion bars oppositely arranged on the first rotation axis relative to the mirror system, wherein the pair of inner torsion bars extend along the first rotation axis to connect the connector ring to the inner suspension ring; and a pair of outer torsion bars oppositely arranged on the second rotation axis relative to the mirror system, wherein the pair of outer torsion bars extend along the second rotation axis to connect the inner suspension ring to the outer actuation system assembly.
Aspect 7: The MEMS device of Aspect 6, wherein the pair of inner torsion bars enable the mirror system to rotate about the first rotation axis, and wherein the pair of outer torsion bars enable the mirror system to rotate about the second rotation axis.
Aspect 8: The MEMS device of Aspect 6, wherein the outer actuation system assembly comprises: an inner actuation ring that encircles the inner suspension assembly and is coupled to the pair of outer torsion bars, the inner actuation ring being formed by a set of inner actuation beams of the plurality of actuation beams; a first torsion connector arranged on the second rotation axis, aligned with the pair of outer torsion bars; a second torsion connector arranged on the second rotation axis opposite the first torsion connector relative to the mirror system and aligned with the pair of outer torsion bars; a first outer actuation segment coupled to the inner actuation ring by the first torsion connector, the first outer actuation segment comprising a first pair of outer actuation beams of the plurality of actuation beams that are connected to the frame; and a second outer actuation segment coupled to the inner actuation ring by the second torsion connector, the second outer actuation segment comprising a second pair of outer actuation beams of the plurality of actuation beams that are connected to the frame.
Aspect 9: The MEMS device of Aspect 8, wherein the plurality of piezoelectric actuators comprises: a first set of piezoelectric actuators, arranged on the set of inner actuation beams of the inner actuation ring, for inducing deflections of the set of inner actuation beams to actuate the mirror system to rotate about the second rotation axis; and a second set of piezoelectric actuators, arranged on the first pair of outer actuation beams and the second pair of outer actuation beams, for inducing deflections of the first pair of outer actuation beams and the second pair of outer actuation beams to actuate the mirror system to rotate about the first rotation axis.
Aspect 10: The MEMS device of Aspect 9, further comprising: a first set of piezoelectric sensors coupled to the set of inner actuation beams, the first set of piezoelectric sensors configured to sense the deflections of the set of inner actuation beams and generate corresponding sensor signals as feedback information for a controller; and a second set of piezoelectric sensors coupled to the first pair of outer actuation beams and the second pair of outer actuation beams, the second set of piezoelectric sensors configured to sense the deflections of the first pair of outer actuation beams and the second pair of outer actuation beams, and generate corresponding sensor signals as feedback information for the controller.
Aspect 11: The MEMS device of Aspect 8, wherein the first pair of outer actuation beams extend in opposite directions from the second rotation axis and connect to the frame at respective first anchor points, wherein the respective first anchor points are arranged at respective angles between the first rotation axis and the second rotation axis, and wherein the second pair of outer actuation beams extend in opposite directions from the second rotation axis and connect to the frame at respective second anchor points, wherein the respective second anchor points are arranged at respective angles between the first rotation axis and the second rotation axis.
Aspect 12: The MEMS device of Aspect 11, wherein the first pair of outer actuation beams are symmetric about the second rotation axis, wherein the second pair of outer actuation beams are symmetric about the second rotation axis, and wherein the first pair of outer actuation beams are symmetric with the second pair of outer actuation beams about the first rotation axis.
Aspect 13: The MEMS device of Aspect 11, wherein the first pair of outer actuation beams are curved to form a first arc that extends partially around the inner actuation ring, and wherein the second pair of outer actuation beams are curved to form a second arc that extends partially around the inner actuation ring.
Aspect 14: The MEMS device of Aspect 11, wherein the first pair of outer actuation beams are straight and extend parallel to the first rotation axis, and wherein the second pair of outer actuation beams are straight and extend parallel to the first rotation axis.
Aspect 15: The MEMS device of Aspect 8, wherein the mirror system is configured to oscillate about the first rotation axis at a first frequency and to oscillate about the second rotation axis at a second frequency that is lower than the first frequency, and wherein the first frequency is based on lengths of the first pair of outer actuation beams and lengths of the second pair of outer actuation beams.
Aspect 16: The MEMS device of any of Aspects 1-15, wherein the outer actuation system assembly comprises: an inner actuation ring coupled to the inner suspension assembly, wherein the inner actuation ring encircles the inner suspension assembly, the inner actuation ring being formed by a set of inner actuation beams of the plurality of actuation beams; a first torsion connector that extends along the second rotation axis; a second torsion connector that extends along the second rotation axis and is arranged opposite the first torsion connector relative to the mirror system; a first outer actuation segment coupled to the inner actuation ring by the first torsion connector, the first outer actuation segment comprising a first pair of outer actuation beams of the plurality of actuation beams that are connected to the frame; and a second outer actuation segment coupled to the inner actuation ring by the second torsion connector, the second outer actuation segment comprising a second pair of outer actuation beams of the plurality of actuation beams that are connected to the frame.
Aspect 17: The MEMS device of Aspect 16, wherein the first pair of outer actuation beams extend in opposite directions from the second rotation axis and connect to the frame at respective first anchor points, wherein the respective first anchor points are arranged at respective angles between the first rotation axis and the second rotation axis, and wherein the second pair of outer actuation beams extend in opposite directions from the second rotation axis and connect to the frame at respective second anchor points, wherein the respective second anchor points are arranged at respective angles between the first rotation axis and the second rotation axis.
Aspect 18: The MEMS device of any of Aspects 1-17, further comprising: an actuation circuit configured to generate actuation signals, and provide the actuation signals to the plurality of piezoelectric actuators to control the deflections of the plurality of actuation beams for actuating rotations of the mirror body about the first rotation axis and the second rotation axis.
Aspect 19: The MEMS device of Aspect 18, further comprising: a plurality of piezoelectric sensors coupled to the plurality of actuation beams, the plurality of piezoelectric sensors configured to sense the deflections of the plurality of actuation beams and generate corresponding sensor signals, wherein the actuation circuit is configured to adjust an actuation of the plurality of piezoelectric actuators based on the corresponding sensor signals to regulate the deflections of the plurality of actuation beams and to control the rotations of the mirror body about the first rotation axis and the second rotation axis.
Aspect 20: A microelectromechanical system (MEMS) device, comprising: a mirror system including a connector ring and a mirror body coupled to the connector ring, wherein the mirror body, arranged inside the connector ring, is configured to rotate about a first rotation axis and to rotate about a second rotation axis that is perpendicular to the first rotation axis; a frame that is rotationally fixed, the frame comprising a frame recess over which the mirror system is suspended; an inner suspension assembly mechanically coupled to the mirror system, the inner suspension assembly comprising a plurality of suspension beams configured to suspend the mirror system over the frame recess, and to enable the mirror system to rotate about the first rotation axis and to rotate about the second rotation axis; and an outer actuation system assembly coupled to and between the inner suspension assembly and the frame, the outer actuation system assembly configured to suspend the mirror system and the inner suspension assembly over the frame recess, and to actuate deflections of the plurality of suspension beams to cause the mirror system to rotate about the first rotation axis and to rotate about the second rotation axis, wherein the outer actuation system assembly includes a plurality of actuation beams configured to deflect based on being actuated, wherein deflection of the plurality of actuation beams induces the deflections of the plurality of suspension beams.
Aspect 21: The MEMS device of Aspect 20, wherein the inner suspension assembly comprises: an inner suspension ring formed by the plurality of suspension beams; a pair of inner torsion bars oppositely relative to the mirror system, wherein the pair of inner torsion bars connect the connector ring to the inner suspension ring and enable the mirror system to rotate about the first rotation axis; and a pair of outer torsion bars oppositely arranged relative to the mirror system, wherein the pair of outer torsion bars connect the inner suspension ring to the outer actuation system assembly, and enable the mirror system to rotate about the second rotation axis.
Aspect 22: The MEMS device of Aspect 21, wherein the outer actuation system assembly comprises: an inner actuation ring that encircles the inner suspension assembly and is coupled to the pair of outer torsion bars, the inner actuation ring being formed by a set of inner actuation beams of the plurality of actuation beams; a first torsion connector arranged on the second rotation axis; a second torsion connector arranged on the second rotation axis opposite the first torsion connector relative to the mirror system; a first outer actuation segment coupled to the inner actuation ring by the first torsion connector, the first outer actuation segment comprising a first pair of outer actuation beams of the plurality of actuation beams that are connected to the frame; and a second outer actuation segment coupled to the inner actuation ring by the second torsion connector, the second outer actuation segment comprising a second pair of outer actuation beams of the plurality of actuation beams that are connected to the frame.
Aspect 23: The MEMS device of any of Aspects 20-22, wherein the outer actuation system assembly comprises: an inner actuation ring coupled to the inner suspension assembly, wherein the inner actuation ring encircles the inner suspension assembly, the inner actuation ring being formed by a set of inner actuation beams of the plurality of actuation beams; a first torsion connector that extends along the second rotation axis; a second torsion connector that extends along the second rotation axis and is arranged opposite the first torsion connector relative to the mirror system; a first outer actuation segment coupled to the inner actuation ring by the first torsion connector, the first outer actuation segment comprising a first pair of outer actuation beams of the plurality of actuation beams that are connected to the frame; and a second outer actuation segment coupled to the inner actuation ring by the second torsion connector, the second outer actuation segment comprising a second pair of outer actuation beams of the plurality of actuation beams that are connected to the frame.
Aspect 24: The MEMS device of any of Aspects 20-22, wherein the outer actuation system assembly comprises: discontinuous actuation ring that is arranged partially around the inner suspension assembly and is coupled to the pair of outer torsion bars, the discontinuous actuation ring being formed by the plurality of actuation beams such that each actuation beam of the plurality of actuation beam is coupled to the frame off-axis from the first rotation axis and the second rotation axis.
Aspect 25: A system configured to perform one or more operations recited in one or more of Aspects 1-24.
Aspect 26: An apparatus comprising means for performing one or more operations recited in one or more of Aspects 1-24.
Aspect 27: A non-transitory computer-readable medium storing a set of instructions, the set of instructions comprising one or more instructions that, when executed by a device, cause the device to perform one or more operations recited in one or more of Aspects 1-24.
Aspect 28: A computer program product comprising instructions or code for executing one or more operations recited in one or more of Aspects 1-24.

The foregoing disclosure provides illustration and description, but is not intended to be exhaustive or to limit the implementations to the precise form disclosed. Modifications and variations may be made in light of the above disclosure or may be acquired from practice of the implementations.

For example, although implementations described herein relate to MEMS devices with a mirror, it is to be understood that other implementations may include optical devices other than MEMS mirror devices or other MEMS oscillating structures. In addition, although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer, or an electronic circuit.

Some implementations may be described herein in connection with thresholds. As used herein, “satisfying” a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

As used herein, the term “component” is intended to be broadly construed as hardware, firmware, or a combination of hardware and software. It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Any of the processing components may be implemented as a central processing unit (CPU) or other processor reading and executing a software program from a non-transitory computer-readable recording medium such as a hard disk or a semiconductor memory device. For example, instructions may be executed by one or more processors, such as one or more CPUs, digital signal processors (DSPs), general-purpose microprocessors, application-specific integrated circuits (ASICs), field programmable logic arrays (FPLAs), programmable logic controller (PLC), or other equivalent integrated or discrete logic circuitry. Accordingly, the term “processor,” as used herein refers to any of the foregoing structures or any other structure suitable for implementation of the techniques described herein. Software may be stored on a non-transitory computer-readable medium such that the non-transitory computer readable medium includes a program code or a program algorithm stored thereon which, when executed, causes the processor, via a computer program, to perform the steps of a method.

A controller including hardware may also perform one or more of the techniques of this disclosure. A controller, including one or more processors, may use electrical signals and digital algorithms to perform its receptive, analytic, and control functions, which may further include corrective functions. Such hardware, software, and firmware may be implemented within the same device or within separate devices to support the various techniques described in this disclosure.

A signal processing circuit and/or a signal conditioning circuit may receive one or more signals (e.g., measurement signals) from one or more components in the form of raw measurement data and may derive, from the measurement signal further information. Signal conditioning, as used herein, refers to manipulating an analog signal in such a way that the signal meets the requirements of a next stage for further processing. Signal conditioning may include converting from analog to digital (e.g., via an analog-to-digital converter), amplification, filtering, converting, biasing, range matching, isolation and any other processes required to make a signal suitable for processing after conditioning.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a and b, a and c, b and c, and a, b, and c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

Further, it is to be understood that the disclosure of multiple acts or functions disclosed in the specification or in the claims may not be construed as to be within the specific order. Therefore, the disclosure of multiple acts or functions will not limit these to a particular order unless such acts or functions are not interchangeable for technical reasons. Furthermore, in some implementations, a single act may include or may be broken into multiple sub acts. Such sub acts may be included and part of the disclosure of this single act unless explicitly excluded.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A microelectromechanical system (MEMS) device, comprising:
a mirror system including a connector ring and a mirror body coupled to the connector ring, wherein the mirror body, arranged inside the connector ring, is configured to rotate about a first rotation axis and to rotate about a second rotation axis that is perpendicular to the first rotation axis;
a frame that is rotationally fixed, the frame comprising a frame recess over which the mirror system is suspended;
an inner suspension assembly mechanically coupled to the mirror system, the inner suspension assembly comprising a plurality of suspension beams configured to suspend the mirror system over the frame recess, and to enable the mirror system to rotate about the first rotation axis and to rotate about the second rotation axis; and
an outer actuation system assembly coupled to and between the inner suspension assembly and the frame, the outer actuation system assembly configured to suspend the mirror system and the inner suspension assembly over the frame recess, and to actuate deflections of the plurality of suspension beams to cause the mirror system to rotate about the first rotation axis and to rotate about the second rotation axis,
wherein the outer actuation system assembly includes a plurality of actuation beams and a plurality of piezoelectric actuators coupled to the plurality of actuation beams, and the plurality of piezoelectric actuators are configured to induce deflections of the plurality of actuation beams to actuate the deflections of the plurality of suspension beams.

2. The MEMS device of claim 1, wherein the plurality of actuation beams are configured to deflect out-of-phase with the deflections of the plurality of suspension beams to cause the mirror system to rotate about the first rotation axis and to rotate about the second rotation axis.

3. The MEMS device of claim 1, wherein first actuation beams of the plurality of actuation beams and first suspension beams of the plurality of suspension beams arranged on a same side of the first rotation axis are configured to deflect in counter-directional directions to cause the mirror system to rotate about the first rotation axis, and
wherein second actuation beams of the plurality of actuation beams and second suspension beams of the plurality of suspension beams arranged on a same side of the second rotation axis are configured to deflect in counter-directional directions to cause the mirror system to rotate about the second rotation axis.

4. The MEMS device of claim 3, wherein the mirror system is configured to rotate about the first rotation axis counter-directionally to a rotation of the first actuation beams about the first rotation axis, and
wherein the mirror system is configured to rotate about the second rotation axis counter-directionally to a rotation of the second actuation beams about the second rotation axis.

5. The MEMS device of claim 1, wherein the mirror system is configured to oscillate about the first rotation axis at a first frequency and to oscillate about the second rotation axis at a second frequency that is lower than the first frequency.

6. The MEMS device of claim 1, wherein the inner suspension assembly comprises:
an inner suspension ring formed by the plurality of suspension beams;
a pair of inner torsion bars oppositely arranged on the first rotation axis relative to the mirror system, wherein the pair of inner torsion bars extend along the first rotation axis to connect the connector ring to the inner suspension ring; and
a pair of outer torsion bars oppositely arranged on the second rotation axis relative to the mirror system, wherein the pair of outer torsion bars extend along the second rotation axis to connect the inner suspension ring to the outer actuation system assembly.

7. The MEMS device of claim 6, wherein the pair of inner torsion bars enable the mirror system to rotate about the first rotation axis, and
wherein the pair of outer torsion bars enable the mirror system to rotate about the second rotation axis.

8. The MEMS device of claim 6, wherein the outer actuation system assembly comprises:
an inner actuation ring that encircles the inner suspension assembly and is coupled to the pair of outer torsion bars, the inner actuation ring being formed by a set of inner actuation beams of the plurality of actuation beams;
a first torsion connector arranged on the second rotation axis, aligned with the pair of outer torsion bars;
a second torsion connector arranged on the second rotation axis opposite the first torsion connector relative to the mirror system and aligned with the pair of outer torsion bars;
a first outer actuation segment coupled to the inner actuation ring by the first torsion connector, the first outer actuation segment comprising a first pair of outer actuation beams of the plurality of actuation beams that are connected to the frame; and
a second outer actuation segment coupled to the inner actuation ring by the second torsion connector, the second outer actuation segment comprising a second pair of outer actuation beams of the plurality of actuation beams that are connected to the frame.

9. The MEMS device of claim 8, wherein the plurality of piezoelectric actuators comprises:
a first set of piezoelectric actuators, arranged on the set of inner actuation beams of the inner actuation ring, for inducing deflections of the set of inner actuation beams to actuate the mirror system to rotate about the second rotation axis; and
a second set of piezoelectric actuators, arranged on the first pair of outer actuation beams and the second pair of outer actuation beams, for inducing deflections of the first pair of outer actuation beams and the second pair of outer actuation beams to actuate the mirror system to rotate about the first rotation axis.

10. The MEMS device of claim 9, further comprising:
a first set of piezoelectric sensors coupled to the set of inner actuation beams, the first set of piezoelectric sensors configured to sense the deflections of the set of inner actuation beams and generate corresponding sensor signals as feedback information for a controller; and
a second set of piezoelectric sensors coupled to the first pair of outer actuation beams and the second pair of outer actuation beams, the second set of piezoelectric sensors configured to sense the deflections of the first pair of outer actuation beams and the second pair of outer actuation beams, and generate corresponding sensor signals as feedback information for the controller.

11. The MEMS device of claim 8, wherein the first pair of outer actuation beams extend in opposite directions from the second rotation axis and connect to the frame at respective first anchor points, wherein the respective first anchor points are arranged at respective angles between the first rotation axis and the second rotation axis, and
wherein the second pair of outer actuation beams extend in opposite directions from the second rotation axis and connect to the frame at respective second anchor points, wherein the respective second anchor points are arranged at respective angles between the first rotation axis and the second rotation axis.

12. The MEMS device of claim 11, wherein the first pair of outer actuation beams are symmetric about the second rotation axis,
wherein the second pair of outer actuation beams are symmetric about the second rotation axis, and
wherein the first pair of outer actuation beams are symmetric with the second pair of outer actuation beams about the first rotation axis.

13. The MEMS device of claim 11, wherein the first pair of outer actuation beams are curved to form a first arc that extends partially around the inner actuation ring, and
wherein the second pair of outer actuation beams are curved to form a second arc that extends partially around the inner actuation ring.

14. The MEMS device of claim 11, wherein the first pair of outer actuation beams are straight and extend parallel to the first rotation axis, and
wherein the second pair of outer actuation beams are straight and extend parallel to the first rotation axis.

15. The MEMS device of claim 8, wherein the mirror system is configured to oscillate about the first rotation axis at a first frequency and to oscillate about the second rotation axis at a second frequency that is lower than the first frequency, and
wherein the first frequency is based on lengths of the first pair of outer actuation beams and lengths of the second pair of outer actuation beams.

16. The MEMS device of claim 1, wherein the outer actuation system assembly comprises:
an inner actuation ring coupled to the inner suspension assembly, wherein the inner actuation ring encircles the inner suspension assembly, the inner actuation ring being formed by a set of inner actuation beams of the plurality of actuation beams;
a first torsion connector that extends along the second rotation axis;
a second torsion connector that extends along the second rotation axis and is arranged opposite the first torsion connector relative to the mirror system;
a first outer actuation segment coupled to the inner actuation ring by the first torsion connector, the first outer actuation segment comprising a first pair of outer actuation beams of the plurality of actuation beams that are connected to the frame; and
a second outer actuation segment coupled to the inner actuation ring by the second torsion connector, the second outer actuation segment comprising a second pair of outer actuation beams of the plurality of actuation beams that are connected to the frame.

17. The MEMS device of claim 16, wherein the first pair of outer actuation beams extend in opposite directions from the second rotation axis and connect to the frame at respective first anchor points, wherein the respective first anchor points are arranged at respective angles between the first rotation axis and the second rotation axis, and
wherein the second pair of outer actuation beams extend in opposite directions from the second rotation axis and connect to the frame at respective second anchor points, wherein the respective second anchor points are arranged at respective angles between the first rotation axis and the second rotation axis.

18. The MEMS device of claim 1, further comprising:
an actuation circuit configured to generate actuation signals, and provide the actuation signals to the plurality of piezoelectric actuators to control the deflections of the plurality of actuation beams for actuating rotations of the mirror body about the first rotation axis and the second rotation axis.

19. The MEMS device of claim 18, further comprising:
a plurality of piezoelectric sensors coupled to the plurality of actuation beams, the plurality of piezoelectric sensors configured to sense the deflections of the plurality of actuation beams and generate corresponding sensor signals,
wherein the actuation circuit is configured to adjust an actuation of the plurality of piezoelectric actuators based on the corresponding sensor signals to regulate the deflections of the plurality of actuation beams and to control the rotations of the mirror body about the first rotation axis and the second rotation axis.

20. A microelectromechanical system (MEMS) device, comprising:
a mirror system including a connector ring and a mirror body coupled to the connector ring, wherein the mirror body, arranged inside the connector ring, is configured to rotate about a first rotation axis and to rotate about a second rotation axis that is perpendicular to the first rotation axis;
a frame that is rotationally fixed, the frame comprising a frame recess over which the mirror system is suspended;
an inner suspension assembly mechanically coupled to the mirror system, the inner suspension assembly comprising a plurality of suspension beams configured to suspend the mirror system over the frame recess, and to enable the mirror system to rotate about the first rotation axis and to rotate about the second rotation axis; and
an outer actuation system assembly coupled to and between the inner suspension assembly and the frame, the outer actuation system assembly configured to suspend the mirror system and the inner suspension assembly over the frame recess, and to actuate deflections of the plurality of suspension beams to cause the mirror system to rotate about the first rotation axis and to rotate about the second rotation axis,
wherein the outer actuation system assembly includes a plurality of actuation beams configured to deflect based on being actuated, wherein deflection of the plurality of actuation beams induces the deflections of the plurality of suspension beams.

21. The MEMS device of claim 20, wherein the inner suspension assembly comprises:
an inner suspension ring formed by the plurality of suspension beams;
a pair of inner torsion bars oppositely relative to the mirror system, wherein the pair of inner torsion bars connect the connector ring to the inner suspension ring and enable the mirror system to rotate about the first rotation axis; and
a pair of outer torsion bars oppositely arranged relative to the mirror system, wherein the pair of outer torsion bars connect the inner suspension ring to the outer actuation system assembly, and enable the mirror system to rotate about the second rotation axis.

22. The MEMS device of claim 21, wherein the outer actuation system assembly comprises:
an inner actuation ring that encircles the inner suspension assembly and is coupled to the pair of outer torsion bars, the inner actuation ring being formed by a set of inner actuation beams of the plurality of actuation beams;
a first torsion connector arranged on the second rotation axis;
a second torsion connector arranged on the second rotation axis opposite the first torsion connector relative to the mirror system;
a first outer actuation segment coupled to the inner actuation ring by the first torsion connector, the first outer actuation segment comprising a first pair of outer actuation beams of the plurality of actuation beams that are connected to the frame; and
a second outer actuation segment coupled to the inner actuation ring by the second torsion connector, the second outer actuation segment comprising a second pair of outer actuation beams of the plurality of actuation beams that are connected to the frame.

23. The MEMS device of claim 20, wherein the outer actuation system assembly comprises:
an inner actuation ring coupled to the inner suspension assembly, wherein the inner actuation ring encircles the inner suspension assembly, the inner actuation ring being formed by a set of inner actuation beams of the plurality of actuation beams;
a first torsion connector that extends along the second rotation axis;
a second torsion connector that extends along the second rotation axis and is arranged opposite the first torsion connector relative to the mirror system;
a first outer actuation segment coupled to the inner actuation ring by the first torsion connector, the first outer actuation segment comprising a first pair of outer actuation beams of the plurality of actuation beams that are connected to the frame; and
a second outer actuation segment coupled to the inner actuation ring by the second torsion connector, the second outer actuation segment comprising a second pair of outer actuation beams of the plurality of actuation beams that are connected to the frame.

24. The MEMS device of claim 21, wherein the outer actuation system assembly comprises:
a discontinuous actuation ring that is arranged partially around the inner suspension assembly and is coupled to the pair of outer torsion bars, the discontinuous actuation ring being formed by the plurality of actuation beams such that each actuation beam of the plurality of actuation beam is coupled to the frame off-axis from the first rotation axis and the second rotation axis.
